(19) United States
(12) Patent Application Publication
(10) Pub. No.: US 2014/0205521 A1
(43) Pub. Date: Jul. 24, 2014

(54) DRY SORBENT INJECTION (DSI) RECOVERY SYSTEM AND METHOD THEREOF

(71) Applicant: Neumann Systems Group, Inc., Colorado Springs, CO (US)

(72) Inventors: David Kurt Neumann, Colorado Springs, CO (US); Claire MacLeod Ohman, Colorado Springs, CO (US); Eric John Klein, Castle Rock, CO (US); Jean-Philippe Feve, Monument, CO (US)

(73) Assignee: Neumann Systems Group, Inc., Colorado Springs, CO (US)

(21) Appl. No.: 13/958,412

(22) Filed: Aug. 2, 2013

Related U.S. Application Data
(60) Provisional application No. 61/754,477, filed on Jan. 18, 2013.

(51) Int. Cl. C01D 7/16; B01D 53/83

(52) U.S. Cl. CPC C01D 7/16; B01D 53/83
USPC 423/209; 423/210; 422/630; 422/187

(57) ABSTRACT

The invention generally relates to system and method for recovering sodium bicarbonate from a solid waste, and more particularly to a method and system for recovering sodium bicarbonate from fly ash of a coal fired plant collected downstream of an injection process for pollution reduction from the industrial process.

This application claims the benefit of U.S. Provisional Patent Application No. 61/754,477 filed on Jan. 18, 2013, which is fully incorporated herein by reference as if fully set forth herein.

### BACKGROUND OF THE INVENTION

1. Field of the Invention

The present invention generally relates to system and method for recovering sodium bicarbonate from a solid waste, and more particularly to a method and system for recovering sodium bicarbonate from fly ash of a coal fired plant collected downstream of an injection process for pollution reduction from the combustion process.

2. Discussion of the Related Art

Dry sorbent injection (DSI) using sodium-based sorbents is an accepted technology for controlling SO₂ and other acid gas emissions in post-combustion flue gases such as those emitted by pulverized coal burning power plants. The dry sorbent, typically either trona or sodium bicarbonate, is injected into the flue gas upstream of the particulate control device, e.g., a baghouse or an electrostatic precipitator (ESP). The dry sorbent reacts with acid gases to produce solid by-products (sodium sulfate in the case of SO₂ control). These reaction products, along with un-reacted sorbent, are removed from the flue gas flow along with the fly ash by the particulate control device. The resulting fly ash mixture is typically landfilled.

DSI systems suffer from high operational expenses due to high cost of the sodium sorbents and excessive chemical usage in the case of SO₂ control. Normalized stoichiometric ratio (NSR) values, defined as moles of Na₂ injected per mol of SO₂ in the flue gas, can range as high as 3 or greater for SO₂ applications targeting 90 percent (%) removal, while the theoretical required amount is 1 mole Na₂/mole SO₂ removed. Thus most DSI systems configured for SO₂ or other pollutant removal are constrained to plants burning low sulfur coal and removal rates typically well below 90 percent (%), or to plants with short remaining lifespan. Additionally, the high sodium concentration present in post-DSI fly ash has been shown to increase the leachability of metals from the fly ash, increasing concerns regarding the disposal of post-DSI fly ash. The leaching behavior of coal combustion products and the environmental implication in road construction is described with reference to U.S. Department of Transportation study. See Wang, et al., Center for Transportation infrastructure and Safety/NUTC Program for the U.S. Department of Transportation, April 2011, which is hereby incorporated by reference as if fully set forth herein.

Therefore, there is a need for a device, method and/or system that addresses the above and other problems.

### SUMMARY OF THE INVENTION

Accordingly, the invention is directed to a dry sorbent injection recovery system and method thereof that substantially obviates one or more of the problems due to limitations and disadvantages of the related art.

An advantage of the invention is to provide recovered sorbent for reducing operational cost of a dry sorbent injection process.

Still yet another advantage of the invention is to reduce the concentration of sodium in post dry sorbent injection fly ash.

Still another advantage of the invention is to reduce the pH of post dry sorbent injection fly ash.

Yet still another advantage of the invention is to reduce the leachability of heavy metals in post dry sorbent injection fly ash.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

An embodiment of the invention relates to system and method for recovering sodium bicarbonate from a solid waste, and more particularly to a method and system for recovering sodium bicarbonate from fly ash of a coal fired plant collected downstream of an injection process for pollution reduction from the combustion process.

Another embodiment is directed towards a method for recovering sodium bicarbonate from solid waste of an industrial process utilizing a dry sorbent in an injection process for pollution reduction from the industrial process. The method includes reacting the solid waste in a series of aqueous reactions to produce a reacted product and reacting the reacted product with carbon dioxide to recover sodium bicarbonate.

Yet another embodiment of the invention is directed towards a process for recovering sodium bicarbonate from solid waste of a coal fired power plant combustion process utilizing a dry sorbent injection process for flue gas desulfurization. The process includes creating an aqueous mixture including the solid waste and water to produce calcium carbonate and sodium hydroxide and subjecting the sodium hydroxide to carbon dioxide to produce sodium bicarbonate.

Still yet another embodiment of invention is directed towards a system for recovering sodium bicarbonate from a solid waste of an industrial process. The system includes a first reactor unit operable to an aqueous mixture of solid waste including sodium carbonate and calcium hydroxide to produce a calcium carbonate and sodium hydroxide. A second reactor unit is in communication with the first reactor unit and the second reactor is operable to react the sodium carbonate, sodium hydroxide and carbon dioxide to produce sodium bicarbonate. A third reactor unit is in communication with the second reactor unit and is operable to react the sodium bicarbonate with an alkaline earth metal hydroxide to produce an alkaline earth metal carbonate and/or sodium hydroxide. The first, second and third reactor are in series. Embodiments of the invention are independent of NSR (mol of Na₂ injected/mol of SO₂ in the gas inlet).

This Summary section is neither intended to be, nor should be, construed as being representative of the full extent and scope of the present disclosure. Additional benefits, features and embodiments of the present disclosure are set forth in the attached figures and in the description herein, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an exemplary diagram of a sorbent recovery process and system according to an embodiment of the invention;

FIG. 2 illustrates an exemplary diagram of a batch process and system for recovering sodium bicarbonate from solid waste according to another embodiment of the invention;

FIG. 3 illustrates an exemplary diagram of a continuous process and system for recovering sodium bicarbonate from solid waste according to another embodiment of the invention;

FIG. 4 illustrates an exemplary diagram of a continuous process and system for recovering sodium bicarbonate from solid waste according to another embodiment of the invention;

FIG. 5 illustrates an exemplary diagram of a process and system for separation of calcium carbonate and fly ash by-products according to another embodiment of the invention;

FIG. 6 illustrates an exemplary graph of NaHCO₃ purity when precipitated from solutions containing NaCl according to Examples 6-9;

FIG. 7 illustrates an exemplary graph illustrating a percent recovery of sodium bicarbonate with increased sodium chloride concentrations according to Examples 6-9; and

FIG. 8A illustrates an exemplary graph illustrating a particle size distribution of raw fly ash according to Example 22;

FIG. 8B illustrates an exemplary graph illustrating a particle size distribution of milled fly ash according to Example 22; and

FIG. 8C illustrates an exemplary graph illustrating a particle size distribution of processed fly ash according to Example 22.

### DETAILED DESCRIPTION OF THE ILLUSTRATED EMBODIMENTS

In order to more fully appreciate the present disclosure and to provide additional related features, each of the following references are incorporated herein by reference in their entirety:

(1) U.S. Pat. No. 2,626,852 by Byrns which discloses a method of recovering sodium sequicarbonate form brines containing sodium carbonate.

(2) U.S. Pat. No. 2,704,239 by Pike which discloses production of soda ash from trona.

(3) U.S. Pat. No. 3,846,535 by Fonseca which discloses a method for absorbing sulfur oxides from gaseous mixtures containing sulfur oxides using a sodium bicarbonate or potassium bicarbonate absorbent and regenerating the absorbent.

(4) U.S. Pat. No. 4,344,650 by Pinsky, et al., which discloses a cyclic method for recovering alkali values from subterranean trona deposits. The ore is contacted via solution mining with an aqueous mining solvent containing sodium hydroxide, the resulting Na₂CO₃-containing solution is withdrawn and carbonated, and sodium sequicarbonate and/or sodium bicarbonate is crystallized and separated from the solution. The crystallized solids are calcined in a direct coal-fired calciner, and the resultant anhydrous soda ash is recrystallized in water to form sodium carbonate monohydrate or anhydrous sodium carbonate, which is recovered as a dense alkali product. Aqueous mining solvent is regenerated by causticization of one or more of the various liquor streams, and the recovery cycle is repeated.

(5) U.S. Pat. No. 4,385,039 by Lowell, et al., which discloses a process for removing sulfur oxides from waste gas is provided. The gas is contacted with a sorbent selected from sodium bicarbonate, trona and activated sodium carbonate and, utilizing an alkaline liquor containing borate ion so as to reduce flow rates and loss of alkalinity, the spent sorbent is regenerated with an alkaline earth metal oxide or hydroxide.

(6) U.S. Pat. No. 4,401,635 by Frint which discloses a method for recovering alkali values from subterranean deposits of trona ore associated with sodium chloride by contacting the trona with an aqueous mining solution containing sodium hydroxide and subsequently utilizing the alkali values contained in the resultant salt- and sodium carbonate-containing solution. The alkali values are preferably crystallized as substantially salt-free sodium carbonate monohydrate, which is dried to recover soda ash. The mother liquor containing all of the salt is then treated to prepare a dilute sodium hydroxide solution, which may be employed as aqueous mining solution in a cyclic method to recover additional alkali values from trona.

(7) U.S. Pat. No. 4,481,172 by Lowell, et al., which discloses a process for removing sulfur oxides from waste gas is provided. The gas is contacted with an activated sodium carbonate sorbent and, utilizing an alkaline ammonia liquor so as to reduce the flow rates and loss of alkalinity, the spent sorbent is regenerated with an alkaline earth metal oxide or hydroxide.

(8) U.S. Pat. No. 4,555,391 by Cryan, et al., which discloses utilization of a soda-type dry sorbent in a dry injection flue gas desulfurization process is increased, without sacrifice in the SO.sub.2 removal efficiency, by reinjecting a portion of the sorbent collected in the baghouse filter back into the hot flue gas stream along with fresh sorbent; the recycled sorbent is optionally cooled below the bag filter temperature prior to its reinjection.

(9) U.S. Pat. No. 4,584,077 by Chlanda, et al., which discloses a process and a system for converting materials comprising sodium carbonate and sodium bicarbonate, such as dry-mined or subterranean deposits of trona, into a liquid comprising sodium carbonate substantially free of sodium bicarbonate. The process and the system incorporate the features of: (a) forming an aqueous solution comprising sodium carbonate and sodium bicarbonate; (b) removing a portion of said sodium bicarbonate from said solution to form a mother liquor comprising sodium carbonate and a reduced amount of sodium bicarbonate; (c) subjecting the mother liquor to electrodialytic water splitting by circulating the water liquor through an electrodialytic water splitter to produce a liquid reaction product comprising sodium carbonate substantially free of sodium bicarbonate; and (d) withdrawing the liquid reaction product comprising sodium carbonate substantially free of sodium bicarbonate from the electordialytic water splitter. The sodium carbonate solutions removed from the water splitter may be used as is, or subjected to further processing to produce a more concentrated final product. Two or three compartment electrodialytic water splitters can be used. The invention also details an effective method and system for isolating sodium carbonate by an electrodialysis process which eliminates the generation of CO₂ gas in the water splitter.

(10) U.S. Pat. No. 4,664,893 by Sarapata, et al., which discloses a process for the dry carbonation of an alkali metal or ammonium carbonate, utilizing a low carbon dioxide-containing carbonating gas stream, and more particularly, a process for the production of a bicarbonate sorbent useful in the desulfurization of flue gases from the low carbon dioxide-content flue gases themselves.

(11) U.S. Pat. No. 5,989,505 by Zolotoochin, et al., which discloses a process for recovery of alkali values from trona in which trona is dissolved, the sodium carbonate in the feed solution is converted to sodium bicarbonate by introducing carbon dioxide, sodium bicarbonate is crystallized and separated from a mother liquor, and sodium bicarbonate in the mother liquor is converted to sodium carbonate by introducing air to form a recirculating dissolving solution which is used to dissolve the trona.

(12) U.S. Pat. No. 8,206,670 by Detournay, et al., which discloses a process for producing sodium bicarbonate for purifying flue gases, according to which an aqueous solution containing sodium sulfate is subjected to electrodialysis to produce a sodium hydroxide solution and a sodium bisulfate solution, the sodium hydroxide solution being carbonated in order to obtain sodium bicarbonate.

(13) U.S. Patent Application Publication No. 2012/0063974 by Kropf which discloses a method of producing trona suitable for flue gas desulfurization comprising mechanically mining a trona ore deposit containing insoluble impurities; crushing the mined trona ore to create a mixture of uncalcined trona-rich particles and impurities-rich particles; beneficiating the crushed uncalcined trona ore to obtain a trona-rich, impurities-depleted ore fraction; and drying the trona-rich ore fraction under non-calcining conditions to yield a dry uncalcined trona ore. A preferred embodiment includes concurrently milling and drying the trona-rich, impurities-depleted ore fraction to recover a low moisture content trona product having a high NaHCO₃:Na₂CO₃ ratio, useful for the efficient dry injection desulfurization of flue gas streams.

One or more embodiments of the invention are directed towards system and method for recovering sodium bicarbonate from a solid waste of an industrial process, and more particularly to a method and system for recovering sodium bicarbonate from fly ash of a coal fired plant collected downstream of an injection process for pollution reduction from the industrial process.

In one embodiment, the processes described herein for the recycling of sodium values found in the fly ash resulting from DSI processes includes lime for the conversion of sodium salts to sodium hydroxide. The sodium hydroxide is then reacted to form sodium bicarbonate or trona. The sodium bicarbonate and/or trona can be recycled to the DSI process unit configured to remove acid gases or other pollutants.

In another embodiment, alkaline earth metal hydroxides, e.g., barium or strontium hydroxide, can be used to recover sodium values present in the post DSI fly ash, e.g., sodium sulfate at the high levels of hydroxide alkalinity present in liquors formed from the dissolution of post-DSI fly ash. The high levels of hydroxide alkalinity include a concentration of greater than 0.1 to 0.15 M.

In embodiments described herein there is no use of ammonia.

In one embodiment, the DSI sorbent used for pollution control of acid gases is sodium-based. The DSI sorbent may include at least one of sodium bicarbonate, sodium carbonate, trona, sodium sequicarbonate and combinations of the same and the like.

Trona is defined as trisodium hydrogendicarbonate dihydrate and includes Na₃(CO₃)(HCO₃).2H₂O and is an evaporite mineral. In one embodiment, trona is a component of a DSI sorbent. In another embodiment, DSI sorbent includes at least one of sodium bicarbonate, sodium carbonate, trona, sodium sesquicarbonate and combinations of the same and the like.

An embodiment is directed towards a method for recovering sodium bicarbonate from solid waste of an industrial process utilizing a dry sorbent in an injection process for pollution reduction from the industrial process. The method includes reacting the solid waste in one or more aqueous reactions to produce a reacted product. The method also includes reacting the reacted product with carbon dioxide to recover sodium bicarbonate. The recycled sodium bicarbonate is recycled or returned to the sorbent or trona used in a DSI process. This recycle or return may be in situ via a recycle loop to the DSI process.

Yet another embodiment of the invention is directed towards a process for recovering sodium bicarbonate from solid waste of a coal fired power plant combustion process utilizing a dry sorbent injection process for removal of acid gases and/or other pollutants. The process includes creating an aqueous mixture including the solid waste and water to produce calcium carbonate and sodium hydroxide and subjecting the sodium hydroxide to carbon dioxide to produce sodium bicarbonate.

Still yet another embodiment of the invention is directed towards a system for recovering sodium bicarbonate from a solid waste of an industrial process. The system includes a first reactor unit operable to an aqueous mixture of solid waste including sodium carbonate and calcium hydroxide to produce a calcium carbonate and sodium hydroxide. A second reactor unit is in communication with the first reactor unit and the second reactor is operable to react the sodium carbonate, sodium hydroxide and carbon dioxide to produce sodium bicarbonate. A third reactor unit in communication with the second reactor unit and is operable to react the sodium bicarbonate with an alkaline earth metal hydroxide to produce an alkaline earth metal carbonate and sodium hydroxide. The first, second and third reactor are in series. Embodiments of the invention are independent of NSR (mole of Na₂ injected/mole of SO₂ in the gas inlet). The system also includes a dry sorbent injection unit for pollution reduction and the dry sorbent injection unit is configured with a recycle stream from the system. The recycle stream includes recovered sodium bicarbonate which can be utilized by the dry sorbent injection for pollution reduction. Of course, further processing of the sodium bicarbonate for dry sorbent injection may be conducted. This further processing may include for example drying, milling and temporary storage of the recovered sodium bicarbonate prior to re-injection. Addition of chemical reagents like anti-caking agents may also be performed at this stage.

In an embodiment of the invention the flue gas desulfurization by dry sorbent injection including trona is effective but because of the accumulation of byproducts in the baghouse it can double the volume and change the chemical characteristics of the fly ash. After SO₂ mitigation the fly ash has a high content of sulfate and carbonate anions and cations such as sodium, calcium and magnesium. In addition, post DSI fly ash has much greater solubility and the alkalinity is increased above, e.g., pH of 12 or greater. These properties can mandate a different disposal process and the increased sodium content can increase the leachability of certain toxic elements contained in the post DSI fly ash.

Although the leaching of cationic elements including Mn, Pb, Sr, Tl, Ag, Be, Cd, Co, and Hg are either decreased or not detectable after trona injection, post DSI ash shows significantly enhanced leaching of anionic elements including arsenic, selenium and others. See Wang et al., Leaching behavior of coal combustion products and the environmental implication in road construction, Center for Transportation infrastructure and Safety/NUTC Program for the US Department of Transportation, April 2011, which is hereby incorporated by reference. This was also verified by Example 21 herein.

Because As and Se have very low threshold contaminant levels in the primary drinking water standard, understanding the enhanced leaching behavior of As and Se from post DSI ash is very significant in assessing the potential environmental impact of fly ashes generated from power plants employing the trona injection process. See Wang, et al., Waste Management, 2007, 7, pp. 1345-1355, which is hereby incorporated by reference.

Embodiments of the invention are directed towards reducing sodium in post DSI fly ash and/or leachability of heavy metals in the post DSI fly ash while simultaneously recovering sodium bicarbonate. The recovery process mitigates the effect of high sodium content on the increased leachability of toxic elements in two ways. The high pH that is the result of the initial reaction between lime and the sodium carbonate in the fly ash decreases the mobility of many toxic elements. The process itself recovers substantially all of the sodium content from the post DSI fly ash and thus removes one significant cause of increased mobility of heavy elements. Moreover, in embodiments herein the sodium values are converted to sodium bicarbonate, (a component of trona), a recycling loop is generated for the DSI system thus reducing costs and improving efficiency of the process. Because sodium bicarbonate is more reactive than trona, the decrease in trona feed to the DSI system is further augmented by the recycling process. By way of illustrative example only, for the case of 60 percent (%) SO₂ removal with an ESP, the NSR for trona injection is equal to 1.5. Recycling 90 percent (%) of the unreacted trona as sodium bicarbonate decreases the Na₂ requirement in the DSI process by 53 percent (%), significantly reducing the operating costs of the DSI process.

In embodiment of the invention, the solid waste may be any waste including sodium carbonate. In a preferred embodiment, the solid waste includes sodium carbonate and calcium hydroxide. In a more preferred embodiment, the solid waste is fly ash collected from flue gas desulfurization process which includes sodium sulfate and un-reacted sodium carbonate. This collected fly ash may be referred to as post dry sorbent injection (DSI) fly ash. This post DSI fly ash can be collected in the electrostatic precipitator or baghouse. In yet another embodiment, fly ash collected downstream of a pollution control facility can be used. It is noted that the post DSI fly ash may also be mixed with other constituents prior to processing with embodiments of this invention.

Fly ash is a composite mixture of silica, alumina, iron oxides, and calcium-bearing minerals. Trace elements include at least 0.1 to 2 percent (%) of the mixture and can include mercury, chromium, and titanium, among others. Two classes of fly ash are Class F and Class C. One difference between these classes is the amount of calcium, silica, alumina, and iron content in the ash. The chemical composition of the fly ash is largely influenced by the chemical content of the coal burned. Class F fly ash contains less than 20 percent (%) lime (CaO) while Class C fly ash contains greater than 20 percent (%) lime. In one embodiment, either Class F or Class C fly ash can be used. In another embodiment, the Class C fly ash will have a lime content of greater than about 20 percent (%). In still another embodiment, the fly ash will have a lime content in a range from about 25 percent (%). to about 35 percent (%).

Reference will now be made in detail to an embodiment of the present invention, example of which is illustrated in the accompanying drawings.

In embodiments of the invention, a DSI sorbent recycling system is designed to work in tandem with current DSI systems to reduce sorbent consumption and solid waste generation and to increase the efficiency of trona use. Also, the processes described herein will work with activated carbon injection systems to capture mercury.

DSI systems for acid gas control are frequently coupled with activated carbon injection systems for mercury control. In one embodiment, the DSI sorbent recycling system would be implemented in conjunction with activated carbon injection. Mercury will be trapped by activated carbon and collected with the fly ash and sodium salts in the bag house or electrostatic precipitator. During the DSI recycling process it is thought that the high pH maintained through the addition of lime ensures that trapped mercury is not leached but instead is collected in the solid products, fly ash and CaCO₃, which are then segregated by filtration.

In another embodiment of the NSG process the fly ash is milled to a particle size of less than 10 microns prior to being subjected to the DSI recycling process. The effect of this is seen in the first step of the recycling process in which calcium carbonate is a byproduct. As calcium carbonate forms, the crystals nucleate to form particle sizes mostly in a range of about 150 microns to about 250 microns.

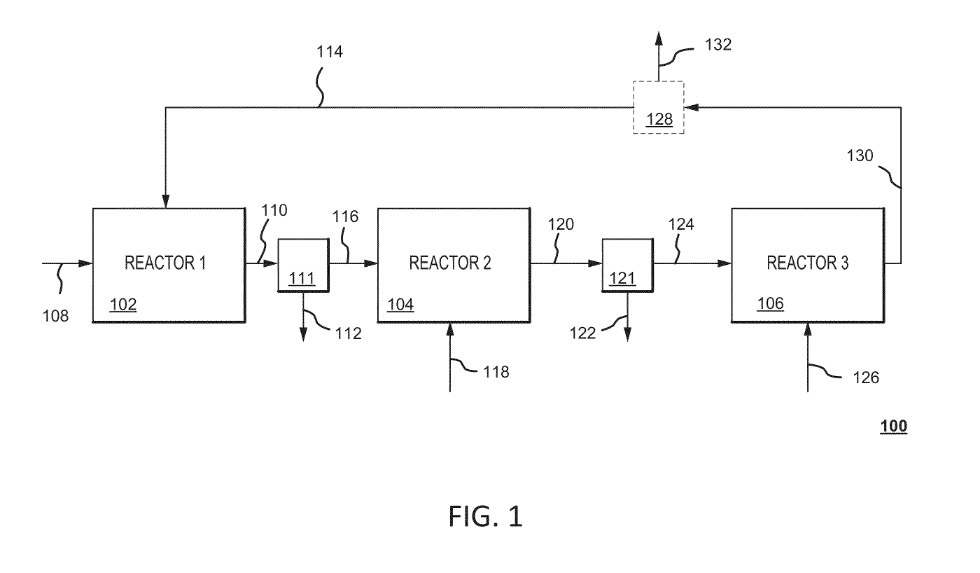

FIG. 1 illustrates an exemplary diagram of a sorbent recovery process and system according to an embodiment of the invention.

Referring to FIG. 1, the system is generally depicted as reference number 100 and configured to work with current DSI systems to reduce sorbent consumption and solid waste generation and to increase the efficiency of sorbent use. The system 100 includes a first reactor 102 in communication with a second reactor 104 and a third reactor 106. The first reactor 102 and third reactor 106 may include a tank, e.g., a mixing tank such as a stir tank reactor, continuous stir tank reactor, or other unit configured to mix at least separate inputs as known in the art. The second reactor may include a gas liquid contactor reactor, e.g., a sparging tank or other reactor. In one embodiment, the second reactor includes a gas liquid contactor which may be a gas-liquid contactor as described with reference to the following U.S. patents and U.S. Patent Application Publication Nos. 7,379,487; 7,871,063; 7,866,638, 6,570,903, 2010/0089232; 2010/0089231; 2011/0061531; 2011/0081288; 2011/0061530; 2011/0072968; 2010/0092368; 2010/0320294; 2010/0319539; 2011/0126710 and U.S. Application No. 61/473,651, each of which are hereby incorporated by reference as if fully set forth herein and will be used.

In this embodiment, the first reactor 102 is a mixing tank. The input 108 to the first reactor 102 includes a solid industrial waste, e.g., fly ash. The fly ash may be collected from a power plant having a dry sorbent injection (DSI) system. This fly ash may be referred to as post DSI fly ash. Other inputs may also be added. For example, lime may be optionally added to tank 102 and utilized to completely react with all of the sodium carbonate present in the fly ash. Sodium chloride may also be added to maintain the sodium chloride concentration in the system at a desired concentration. In addition, a recycle input 114 including an aqueous solution of sodium chloride, sodium sulfate, sodium hydroxide and/or sodium carbonate may be utilized. In this embodiment, a reaction occurs according to Equation 1 in the reactor 102.

Na₂CO₃(aq)+Ca(OH)₂(aq)->CaCO₃(s)+2NaOH(aq) (Equation 1)

The output 110 includes fly ash that contains CaCO₃ and sodium sulfate, and an aqueous solution of sodium hydroxide NaOH, sodium sulfate Na₂SO₄, sodium chloride NaCl and/or sodium carbonate Na₂CO₃. The output 110 is separated and/or filtered with a solid liquid separator 111 to obtain a mixture of fly ash, calcium carbonate, and sodium sulfate which then may be collected in output 112. In another embodiment, there may be no calcium hydroxide in Equation (1) due to no calcium oxide present in the solid waste, for example post DSI fly ash. In such case, the output stream 110 would include dissolved NaOH, Na₂CO₃, Na₂SO₄ and/or NaCl. In this configuration, the output 112 from filter 111 contains a mixture of solid waste, e.g. fly ash, and sodium sulfate.

The output stream 116 is an input stream to the second reactor 104 and includes unreacted Na₂CO₃, dissolved sodium sulfate Na₂SO₄, sodium chloride NaCl and/or sodium hydroxide NaOH. Moreover, another input 118 containing at least CO₂ (g) can be provided to the second reactor 104 as input 118. The input 118 can include other components such as NaCl in a range from about 10 to about 25 percent by mass. The high concentration of NaCl decreases the solubility of sodium bicarbonate NaHCO₃ thus leading to precipitation of the solid NaHCO₃ product. The following reactions according to Equations 2 and 3 take place in reactor 2.

NaOH(aq)+CO₂(g)->NaHCO₃(s) (Equation 2)

Na₂CO₃(aq)+H₂O(aq)+CO₂(g)->2NaHCO₃(s) (Equation 3)

In another embodiment, based on reaction conditions in the second reactor 104 including pH and CO₂ stoichiometry, the precipitated product may contain one or more of sodium bicarbonate, sodium carbonate, trona and sodium sesquicarbonate. It is thought that as the CO₂ stoichiometry decreases and the pH increases that the equilibrium shifts from precipitation of sodium bicarbonate towards precipitation of trona, sodium sesquicarbonate and sodium carbonate. Although in this case the CO₂ requirement is lower, the precipitated products are significantly less reactive than sodium bicarbonate when recycled back for use as dry sorbent in the DSI system.

The output 120 of the reactor 104 includes sodium bicarbonate NaHCO₃ (s), sodium sulfate Na₂SO₄ and sodium chloride NaCl. The output 120 is separated and/or filtered with a liquid solid separator 121. The separator 121 has an output 122 including solids, e.g., NaHCO₃ (s) and an output 124 as an aqueous stream containing dissolved components of NaHCO₃, NaCl and Na₂SO₄. The solids (output 122) are not recycled. The output 122 can optionally be sent to a dry sorbent injection unit as a recycle stream (not shown). The dry sorbent injection unit is configured for pollution reduction and to receive recycle stream containing the sodium bicarbonate. The recycle stream includes recovered sodium bicarbonate which can be utilized by the dry sorbent injection for pollution reduction. Of course, further processing of the sodium bicarbonate for dry sorbent injection may be conducted.

The liquid 124 goes on to the third reactor 106. The input stream 124 includes dissolved solids, e.g., NaHCO₃, Na₂SO₄ and/or NaCl. Alkaline earth metal hydroxide is added via input 126 to the reactor tank 106 to facilitate the reaction. Reactions according to Equations 4, 5 and 6 take place in the third reactor 106. When Equation 6 is being utilized an additional reactor unit (not shown) may be utilized to separate the by-products of Equations 4 and 5 (alkaline earth metal carbonate) from those of Equation 6 (alkaline earth metal sulfate) such that these by-products may be individually salable. These by-products may be used in other industrial processes, e.g. barium sulfate may be used in drilling applications and calcium sulfate may be used in wallboard manufacturing. Of course there are other industrial uses for these by-products.

2NaHCO₃(aq)+(Alkaline Earth Metal)(OH)₂.nH₂O(aq)->Na₂CO₃(aq)+(AEM)CO₃(s)++(2+n)H₂O(aq) (Equation 4)

Na₂CO₃(aq)+(AEM)(OH)₂.nH₂O(aq)->2NaOH(aq)+(AEM)CO₃(s)+nH₂O (Equation 5)

Na₂SO₄(aq)+(AEM)(OH)₂.nH₂O(aq)->(AEM)SO₄.nH₂O(aq)+2NaOH (Equation 6)

As shown with regard to reactions according to Equations 4, 5 and 6 an Alkaline earth metal (AEM) may be utilized. In a preferred embodiment, the AEM may include calcium, strontium, or barium in either Equation 4, 5 and 6. In Equation 6, n is a whole number in a range from 0 to 2 or 8. By way of illustrative embodiment, calcium may be used in Equation 6 as represented with Equation 7. In alternative embodiment, barium may be used in Equation 6 as represented with Equation 8. In Equation 8, n is 0, 1 or 8. In one alternative embodiment, strontium may be used in Equation 6 as represented with Equation 9. In Equation 9, n is a whole number including 0, 1 or 8.

Na₂SO₄(aq)+Ca(OH)₂(aq)+2H₂O(aq)->CaSO₄.2H₂O(aq)+2NaOH(aq) (Equation 7)

Na₂SO₄(aq)+Ba(OH)₂.nH₂O(aq)->BaSO₄(aq)+2NaOH(aq) (Equation 8)

Na₂SO₄(aq)+Sr(OH)₂.nH₂O(aq)->SrSO₄(aq)+2NaOH(aq) (Equation 9)

Moreover, the recycle stream 114 is utilized to recycle an aqueous solution of sodium sulfate, sodium chloride, sodium hydroxide and/or sodium carbonate. Optionally, the output 130 may be sent to a solid liquid separator 128 to remove carbonate solids via output stream 132.

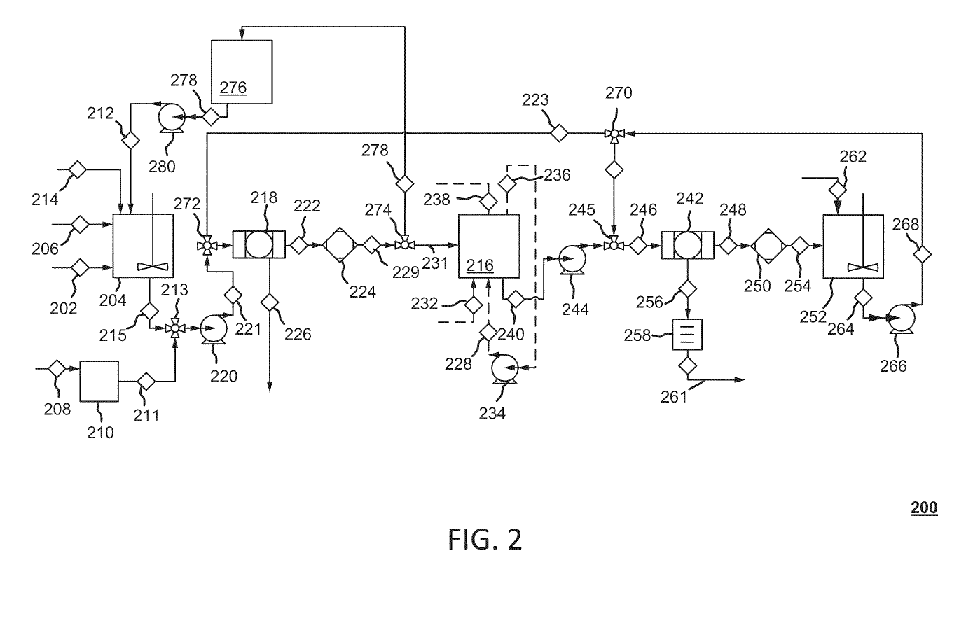

FIG. 2 illustrates an exemplary diagram of a batch process and system for recovering sodium bicarbonate from solid waste according to another embodiment of the invention.

Referring to FIG. 2, the batch process is described for recycling sodium bicarbonate from solid waste of a coal fired power plant combustion utilizing a sodium-based dry sorbent injection system for emissions control. The emissions control may include any type of emission control, e.g., desulfurization. This batch process embodiment is described with regard to Steps 1-8, but the processing may be conducted in any order and the order of the steps is used for simplicity of description only and the batch process is not intended to be limited to this specific order.

The process is generally represented with reference to number 200. The process 200 includes inputting solid waste including one or more sodium carbonate, sodium sulfate, lime, post DSI fly ash, and combinations of the same and the like.

Step 1. Fly ash 202 is collected from the particulate removal device, e.g., bag house, of the power plant having a sodium-based dry sorbent injection (DSI) system. The fly ash 202 is fed to the mixing tank 204. Fly ash 202 includes one or more of sodium sulfate (DSI reaction product) and sodium carbonate (un-reacted DSI sorbent, due to sorbent calcination in the DSI process) from the reaction of dry sorbent with the flue gas in the DSI process. This fly ash may be referred to as post DSI fly ash. It is thought that the fly ash 202 may also contain sodium sulfite. Water with stream 206 is added to the tank 204 when additional water make-up other than the cake wash water 208 is needed for water balance.

In tank 204, the slurry is mixed for approximately 30 minutes or longer. Sodium carbonate dissolves into solution, while the sodium sulfate does not since at steady state sodium sulfate will reach saturation due to high concentrations in the recycle stream 212. Due to formation of NaOH in the mixing tank 204, the OH⁻ concentration increases to about 0.5-0.7 M (pH=13 or greater). The following reactions according to Equations 10 and 11 take place in the mixing tank 204, utilizing the native CaO in the fly ash:

CaO(s)+H₂O(aq)->Ca(OH)₂(aq) (Equation 10)

Na₂CO₃(aq)+Ca(OH)₂(aq)->CaCO₃(s)+2NaOH(aq) (Equation 11)

Depending on the CaO concentration in the fly ash external lime may be added via input 214. This external lime is utilized to further add in the conversion of Na₂CO₃ to CaCO₃ and NaOH. Make-up NaCl is also added in stream 214 to maintain NaCl concentration in the system at a pre-determined target in the range of about 5 to about 25 percent by weight. Bulk NaCl is added only in the first batch, after which only make-up amounts of NaCl are required to compensate for losses of NaCl through the filter cakes.

Step 2 The slurry from the mixing tank 204 exits with stream 215 and is pumped at pressures up to 25 psi or greater via input 221 into and through the filter press 218 using the high-head pump 220. Alternatively, a solids/liquid separation device other than a filter press may be used. The liquid stream 222 from the filter press 218, which contains any unreacted dissolved Na₂CO₃, dissolved Na₂SO₄, NaCl and NaOH, is fed into the sparging tank 216 via an optional heat exchanger 224 to remove the heat of reaction via streams 229 and 231. Alternatively, a cooling system may be incorporated directly into the reaction tank 204 or the heat exchanger 224 may be located between three way valve 272 and the filter press 218. The concentrations of NaOH and Na₂SO₄ in the solution are in range from about 0.5 to about 1.1 M and 0.43-1.13 M, respectively, as modeled by our laboratory tests. The concentration of Na₂CO₃ in the initial mixture in 204 as modeled by our laboratory tests is 0.53 M. In other embodiments, the initial Na₂CO₃ concentration will be dependent on the normalized stoichiometric ratio (NSR) of the DSI process (an NSR value of 3.2 was assumed for the demonstration tests). The concentration of Na₂CO₃ leaving mixing tank 204 is dependent on the concentration of lime in the fly ash as well as the amount of additional lime (if any) added in stream 214. The solids stream 226 from the filter press contains fly ash, calcium carbonate and sodium sulfate, and may be taken out of the process. A cake wash 211 is employed to rinse the filter cake in filter press 218 with fresh water, so as to recover any soluble sodium from the cake to maximize sodium bicarbonate product yield. The output of the cake wash is sent to the sparging tank 216 via heat exchanger 224. Meanwhile, step 1 is repeated.

Step 3. Once all the liquid from the filter press 218 is transferred to the sparging tank 216, a CO₂ source (CO₂ or post-DSI flue gas) is fed into the sparging tank 216 via a sparging device through stream 232. The sparging tank 216 is optionally sealed to allow the CO₂ to be recycled through stream 228 using CO₂ vacuum pump 234 and recycled via input 236. In the sparging tank 216 CO₂ reacts with NaOH and Na₂CO₃ to produce NaHCO₃. In one embodiment, the sparging time is in a range from about 40 to about 100 minutes to allow full conversion to NaHCO₃ through the reactions below described with reference to Equations 12 and 13. The sparging tank 216 includes an output 238 as an exhaust stream. The mixture leaving the sparging tank in the stream 240 has an Off concentration that is very low with a pH in a range from about 7 to about 9.

NaOH(aq)+CO₂(g)->NaHCO₃(s) (Equation 12)

Na₂CO₃(aq)+CO₂(g)+H₂O(aq)->2NaHCO₃(s) (Equation 13)

Step 4. Once the sparging is completed, the mixture 240 from the sparging tank 216 is pumped at pressures up to 25 psi or greater through the filter press 242 using high-head pump 244 to filter out the sodium bicarbonate product. The output 246 of pump 244 is sent to the filter press 242 via valve 245. The liquid stream 248 from the filter press 242, which contains dissolved NaHCO₃ in equilibrium with the solid product in the sparge reaction as well as dissolved Na₂SO₄ and NaCl, goes into the lime addition tank 252 via an output 254 of heat exchanger 250 to remove heat of reaction. Alternatively, a cooling system may be incorporated directly into the reaction tank 216 or the heat exchanger 250 may be located between three way valve 245 and the filter press 242. Sodium bicarbonate, the desired product, leaves the filter press 242 in the solids stream 256. The sodium bicarbonate is then optionally dried to a specified moisture content required by the DSI process in a low temperature drying unit 258 with an output 261, to avoid calcining to Na₂CO₃ during the drying process. When the sparging tank is emptied out, step 2 is repeated. After step 2 is completed, step 3 is repeated.

Step 5. Lime 262 is added to the lime addition tank 252 In this embodiment, the mixture is stirred for approximately 30 minutes or longer. The combined OH⁻ and CO₃²⁻ concentration in the tank 252 increases to approximately 0.1-0.5 M due to formation of NaOH and Na₂CO₃. Calcium carbonate and calcium sulfate are also formed in the lime addition tank 252. Reactions according to Equations 14, 15 and 16 take place in the lime addition tank 252.

2NaHCO₃(aq)+Ca(OH)₂(aq)->CaCO₃(s)+Na₂CO₃(aq)+2H₂O(aq) (Equation 14)

Na₂CO₃(aq)+Ca(OH)₂(aq)->CaCO₃(s)+2NaOH(aq) (Equation 15)

Na₂SO₄+Ca(OH)₂+2H₂O->CaSO₄.2H₂O+2NaOH (Equation 16)

In an alternative embodiment, Equation 16 may utilize Ba(OH)₂.nH₂O or Sr(OH)₂.nH₂O as described with reference to Equations 8 and 9 herein.

Step 6. After approximately 30 minutes or longer of stirring, the mixture from the lime addition tank 252 is transferred via output 264 to pump 266 having an output through a valve 270 and 272, e.g., three way valves. Valve 272 directs output 268 to the filter press 218. The liquid stream from the filter press 218 is transferred through heat exchanger 224 to remove heat of reaction, and through the three-way valve 274 to the holding tank 276 via output 278 from valve 274. Alternatively, a cooling system may be incorporated directly into the reaction tank 252 or the heat exchanger may be located between three way valve 272 and the filter press 218. The holding tank 276 has an output 278 sent to a pump 280 having an output 212. The solids stream 226 containing calcium carbonate and calcium sulfate is taken out of the process. Alternatively, stream 268 can be sent directly to the fly ash mixing tank 204, bypassing the filtration step, if high purity CaCO₃ and/or CaSO₄ by-products are not desired. In other implementations, stream 268 can be sent to a separate solid liquid separator instead of sharing filter press 218 with step 2.

Step 7. Once the lime addition tank 252 is emptied out, steps 4 and 5 are repeated. After step 6 is completed, step 2 is repeated.

Step 8. Once the mixing tank 304 is emptied out in step 7, liquid from the holding tank 276 is transferred to the mixing tank 204 using a low-head pump 280.

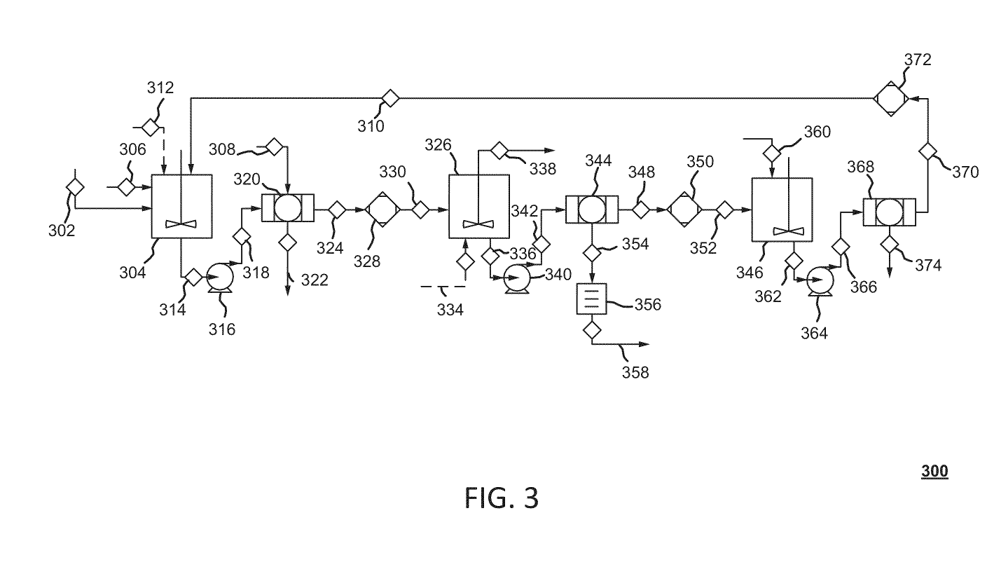

FIG. 3 is illustrates an exemplary diagram of a continuous process and system for recovering sodium bicarbonate from solid waste according to another embodiment of the invention.

Referring to FIG. 3, the continuous process is generally shown with reference to number 300. The process 300 is used to recover sodium bicarbonate from solid waste of a coal fired power plant combustion utilizing a sodium-based dry sorbent injection system for emissions control. The emissions control may include any type of emission control, e.g., desulfurization. This continuous process embodiment is described with regard to Steps 1-6, but the processing may be conducted in any order and the order of the steps is used for simplicity of description only and the process is not intended to be limited to this specific order.

Step 1. Fly ash 302 collected from the particulate removal device, e.g., bag house, of the power plant having a sodium-based dry sorbent injection (DSI) system is fed to the agitated tank 304 through stream 302. The fly ash contains sodium sulfate and residual sodium carbonate from the reaction of dry sorbent with the flue gas in the DSI process. Water is added to the tank 304 via input 306 if additional water other than the cake wash water 308 is needed for water balance. The residence time for the mixture in tank 304 is in a range from about 30 to about 60 minutes. Sodium carbonate dissolves into solution, while the sodium sulfate does not since at steady state sodium sulfate will reach saturation due to high concentrations in the recycle stream 310. Due to formation of NaOH in the mixing tank 304, the OH⁻ concentration increases to range of approximately 0.5-0.7 M (pH˜13 or greater). Reactions according to Equations 17 and 18 take place in the mixing tank 304, utilizing native CaO in the fly ash.

CaO(s)+H₂O(aq)->Ca(OH)₂(aq) (Equation 17)

Na₂CO₃(aq)+Ca(OH)₂(aq)->CaCO₃(s)+2NaOH(aq) (Equation 18)

Depending on the CaO concentration in the fly ash, external lime may be added via stream 312 as required to reach the target for conversion of Na₂CO₃ to CaCO₃ and NaOH. In stream 312, NaCl is added to the mixing tank 304 via stream 312 to decrease solubility of sodium bicarbonate in the solution later in the process. The range of NaCl concentration in tank 304 is in a range from about 5 to about 25 weight percent (wt %) with approximately 10 wt % giving a combination of good purity and yield of NaHCO₃. After NaCl concentration reaches about 5 to about 25 wt % throughout the system, only make-up amounts of NaCl are required to compensate for losses of NaCl through the filter cakes.

Step 2. The slurry from the mixing tank 304 is output via stream 314 and sent to a pump 316 and pumped via stream 318 to and through the filtration process 320. The solids stream 322 from the filtration unit 320 contains fly ash, calcium carbonate and sodium sulfate, and may be taken out of the process. A cake wash 308 is employed to recover any soluble sodium from the cake to maximize sodium bicarbonate product yield. A liquid stream 324 out of the filtration unit 320 is fed to the sparging tank 326 via heat exchanger 328 having an output 330 to remove heat of reaction. Alternatively, the heat exchanger 328 may be integrated into the reaction tank 304 or may be located between pump 316 and the filtration process 320. The concentrations of NaOH and Na₂SO₄ in the solution are in range from about 0.5 to about 1.1 M and about 0.4 to about 1.1 M, respectively, as modeled by our laboratory tests. The concentration of Na₂CO₃ in the initial mixture in 404 as modeled by our laboratory tests is 0.5 M. In actuality, the initial Na₂CO₃ concentration will be dependent on the normalized stoichiometric ratio (NSR) of the DSI process. The concentration of Na₂CO₃ leaving 304 is dependent on the concentration of lime in the fly ash as well as the amount of additional lime (if any) added in stream 312.

Step 3. CO₂ is fed into the sparging tank 326 through stream 334. Note that CO₂ could be supplied from a slipstream of flue gas, preferably taken downstream of the DSI system and baghouse such that acid gas concentration is low. The sparging tank 326 is optionally sealed to allow the CO₂ to be recycled (not shown). In the sparging tank 326 CO₂ reacts with NaOH and Na₂CO₃ to produce NaHCO₃. The sparging tank residence time is in a range from about 40 to about 100 minutes or longer to allow full conversion to NaHCO₃. Note that any gas-liquid contactor can be used in place of a sparger tank. The mixture leaving the sparging tank in the stream 336 has Off concentration that is very low (pH˜7-9). An output 338 is an exhaust output. The following reactions take place according to Equations 19 and 20 in the sparging tank 326:

NaOH(aq)+CO₂(g)->NaHCO₃(s) (Equation 19)

Na₂CO₃(aq)+CO₂(g)+H₂O(aq)->2NaHCO₃(s) (Equation 20)

Step 4. The output 336 is sent to a pump 340 having an output 342 which undergoes the filtration process in a filter unit 344 to filter out the sodium bicarbonate product. The liquid stream 348 from the filtration process including dissolved NaHCO₃ in equilibrium with the solid product in the sparge reaction as well as dissolved Na₂SO₄ and NaCl is transferred to a lime addition tank 346 via an outlet 348 to a heat exchanger 350 having an output 352 to remove heat of reaction. Alternatively, the heat exchanger 350 may be integrated into the sparge tank 326 or may be located between pump 340 and the filtration process 344. Sodium bicarbonate, the desired product, leaves the filtration process 344 in a solids stream 354. The sodium bicarbonate is then optionally dried to a specified moisture content required by the DSI process in a low temperature dryer to avoid calcining to Na₂CO₃ during the drying process via a drying unit 356 having an output 358.

Step 5. Lime is added to the lime addition tank 346 via stream 360. The residence time is approximately 30 minutes or greater. The combined OH⁻ and CO₃²⁻ concentrations in the tank 346 increases to a range from about 0.1 to about 0.5 M due to formation of NaOH and/or Na₂CO₃. Calcium carbonate and calcium sulfate are also formed in the lime addition tank 346. The following reactions take place in accordance with Equations 21, 22, and 23 in the lime addition tank 446.

2NaHCO₃(aq)+Ca(OH)₂(aq)->CaCO₃(s)+Na₂CO₃(aq)+2H₂O(aq) (Equation 21)

Na₂CO₃(aq)+Ca(OH)₂(aq)->CaCO₃(s)+2NaOH(aq) (Equation 22)

Na₂SO₄+Ca(OH)₂+2H₂O->CaSO₄.2H₂O+2NaOH (Equation 23)

In an alternative embodiment, Equation 23 may utilize Ba(OH)₂.nH₂O or Sr(OH)₂.nH₂O as described with reference to Equation 8 and 9 herein.

Step 6. An output of the lime addition tank 362 is sent to a pump 364 having an output 366, which goes through the filtration process via a filter unit 368. The liquid stream 370 is recycled to the tank 304 via heat exchanger 372 having an output 410 to remove heat of reaction. Alternatively, the heat exchanger 372 may be integrated into the reaction tank 346 or may be located between pump 364 and the filtration process 368. The solids stream 374 containing calcium carbonate and calcium sulfate is taken out of the process. Alternatively, stream 366 can bypass the filter unit 368 and be sent directly to heat exchanger 372 if CaCO₃ and/or CaSO₄ by-products are not desired.

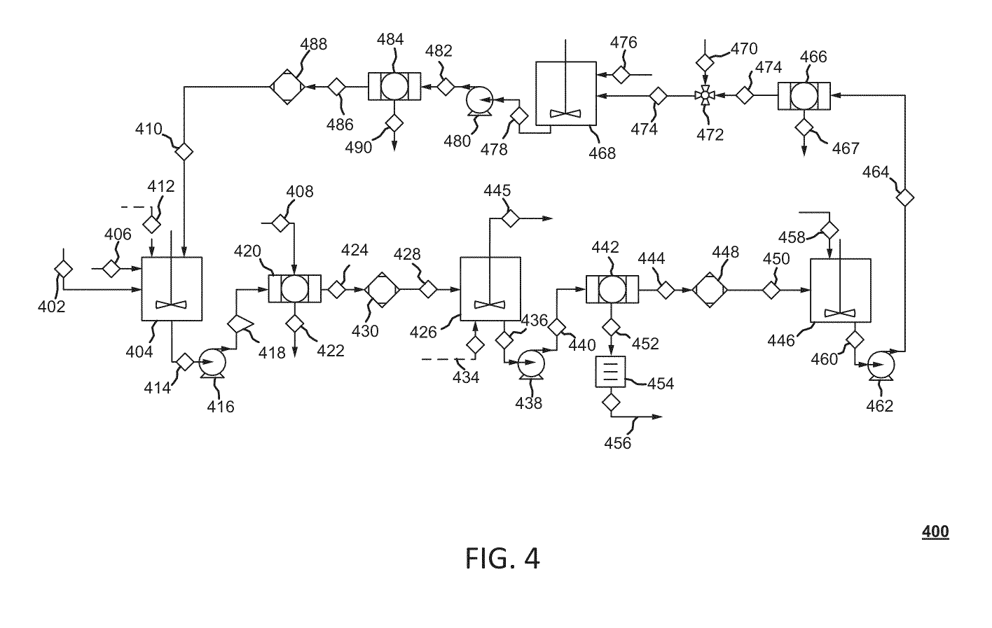

FIG. 4 illustrates an exemplary diagram of a continuous process and system for recovering sodium bicarbonate from solid waste according to another embodiment of the invention.

Referring to FIG. 4, the continuous process is generally shown with reference to number 400. The process 400 is used to recover sodium bicarbonate from solid waste of a coal fired power plant combustion utilizing a sodium-based dry sorbent injection system for emissions control. The emissions control may include any type of emission control, e.g., desulfurization. This continuous process embodiment is described with regard to Steps 1-6, but the processing may be conducted in any order and the order of the steps is used for simplicity of description only and the process is not intended to be limited to this specific order.

An additional fourth tank 468 is used in this embodiment. In this fourth tank 468, sodium sulfate (Na₂SO₄) is converted to NaOH following the neutralization of the fluid leaving tank 446 using HCl. The reason for this neutralization step is that it allows for the complete precipitation of calcium sulfate, thus recovering the associated sodium values as sodium bicarbonate, and preventing the sodium sulfate from contaminating the product sodium bicarbonate as it builds up during recycle operations.

Step 1. Fly ash is input via stream 402. The fly ash, which can be collected from the particulate removal device of the power plant having a sodium-based dry sorbent injection (DSI) system, is fed to the agitated tank 404 through stream 402. The fly ash contains sodium and residual sodium carbonate from the reaction of dry sorbent with the flue gas in the DSI process. Water 406 is added to the tank 404 if additional water other than the cake wash water 408 is needed for water balance. The residence time for the mixture in tank 404 is in a range from about 30 to about 60 minutes or greater. Sodium carbonate dissolves into solution, while the sodium sulfate does not since at steady state sodium sulfate will reach saturation due to high concentrations in the recycle stream 410. Due to formation of NaOH in the mixing tank 404, the OH⁻ concentration increases to approximately 0.5-0.7 M (pH˜13 or greater). Reactions according to Equations 24 and 25 take place in the mixing tank 404, utilizing native CaO in the fly ash.

CaO(s)+H₂O(aq)->Ca(OH)₂(aq) (Equation 24)

Na₂CO₃(aq)+Ca(OH)₂(aq)->CaCO₃(s)+2NaOH(aq) (Equation 25)

Depending on the CaO concentration in the fly ash, external lime may be added as required via stream 412 to reach the target for conversion of Na₂CO₃ to CaCO₃ and NaOH. In stream 412, NaCl is added to the mixing tank 404 via input 412 to decrease solubility of sodium bicarbonate in the solution later in the process. The range of NaCl concentration in tank 404 is in a range from about 5 to about 25 weight percent (wt %) with approximately 10 wt % giving a combination of good purity and yield of NaHCO₃. After NaCl concentration reaches about 5 to about 25 wt % throughout the system, only make-up amounts of NaCl are required to compensate for losses of NaCl through the filter cakes.

Step 2. The slurry from the mixing tank 404 is output via stream 414 to a pump 416 and pumped via stream 418 through the filtration process via filter unit 420. The solids stream 422 from the filtration process contains fly ash, calcium carbonate and sodium sulfate, and may be taken out of the process. A cake wash 408 is employed to recover any soluble sodium from the cake to maximize sodium bicarbonate product yield. Liquid is fed via stream 424 out of the filtration unit 420 to the sparging tank 426 via input 428 from a heat exchanger 430 to remove heat of reaction. Alternatively, the heat exchanger 430 may be integrated into the reaction tank 404 or may be located between pump 416 and the filtration process 420. In this embodiment, the concentrations of NaOH and Na₂SO₄ in the solution are in a range from about 0.5 to about 1.1 M and about 0.4 to about 1.1 M, respectively, as modeled by our laboratory tests. The concentration of Na₂CO₃ in the initial mixture in 404 as modeled by our laboratory tests is 0.5 M. In actuality, the initial Na₂CO₃ concentration will be dependent on the normalized stoichiometric ratio (NSR) of the DSI process. The concentration of Na₂CO₃ leaving 404 is dependent on the concentration of lime in the fly ash as well as the amount of additional lime (if any) added in stream 412.

Step 3. CO₂ is fed into the sparging tank 426 through stream 434. Note that CO₂ could be supplied from a slipstream of flue gas, preferably taken downstream of the DSI system and baghouse such that acid gas concentration is low. The sparging tank 426 is optionally sealed to allow the CO₂ to be recycled (not shown). In the sparging tank 426 CO₂ reacts with NaOH and Na₂CO₃ to produce NaHCO₃. The sparger tank residence time is approximately 40 to 100 minutes or greater to allow full conversion to NaHCO₃. Note that any gas-liquid contactor can be used in a place of a sparging tank. The mixture leaving the sparging tank in the stream 436 has Off concentration that is very low (pH˜7-9). The output 436 is sent to a pump 438 and output via stream 440 to a filter press unit 442. Also, an exhaust stream 444 is sent to an exhaust system (not shown). The following reactions take place according to Equations 26 and 27 in the sparging tank 426

NaOH(aq)+CO₂(g)->NaHCO₃(s) (Equation 26)

Na₂CO₃(aq)+CO₂(g)+H₂O(aq)->2NaHCO₃(s) (Equation 27)

Step 4. The mixture 440 from the sparging tank 426 undergoes the filtration process with a filter unit 442 to filter out the sodium bicarbonate product. An output of the filter unit 442 includes a liquid stream 444 from the filtration process, which contains dissolved NaHCO₃ in equilibrium with the solid product in the sparge reaction as well as dissolved Na₂SO₄ and NaCl, goes into the lime addition tank 446 via heat exchanger 448 to remove heat of reaction. The heat exchanger 448 has an output 450 to the lime addition tank 446. Alternatively, the heat exchanger 448 may be integrated into the sparge tank 426 or may be located between pump 438 and filtration process 442. Sodium bicarbonate, the desired product, leaves the filtration process 442 in the solids stream 452. The sodium bicarbonate is then optionally dried to a specified moisture content required by the DSI process in a low temperature dryer 454 to avoid calcining to Na₂CO₃ during the drying process. The dryer 454 has an output 456.

Step 5. Lime is added to the lime addition tank 446 via stream 458. The residence time is approximately 30 minutes or greater. The combined Off and CO₃²⁻ concentrations in the tank 446 increases to range of approximately 0.1 to 0.5 M due to formation of NaOH and/or Na₂CO₃. Calcium carbonate is also formed in the lime addition tank 446. Reactions according to Equations 28 and 29 take place in the lime addition tank 446.

2NaHCO₃(aq)+Ca(OH)₂(aq)->CaCO₃(s)+Na₂CO₃(aq)+2H₂O(aq) (Equation 28)

Na₂CO₃(aq)+Ca(OH)₂(aq)->CaCO₃(s)+2NaOH(aq) (Equation 29)

Step 5. The output 460 is sent to a pump 462 and the mixture via output 464 from lime addition tank 446 is sent to lime addition tank 468 through filtration unit 466 to remove CaCO₃ by-product via stream 467. An input of HCl via stream 470 is added to neutralize all, some or none of the solution prior to mixing in lime addition 468. The input 470 is sent to a valve 472 and added to output 474 of the filter unit 466. The output 475 of valve 472 is sent to the lime addition tank 468. Lime is added via stream 476. This neutralization reaction can serve as NaCl make-up for the system. Alternatively, another acid compatible with the system can be used for neutralization. Although neutralizing the NaOH and/or Na₂CO₃ precludes its recovery as NaHCO₃, this step of the process may be necessary to allow the reaction in lime addition tank 468 to proceed, decreasing Na₂SO₄ concentration in the system. The mixture residence time in tank 468 is approximately 30 to 60 minutes or greater. The OH⁻ concentration in the tank 468 increases to approximately 0.15 M due to the formation of NaOH. Equations 30 and 31 illustrate reactions that describes the neutralization reaction.

NaOH(aq)+HCl(aq)->NaCl(aq)+H₂O(aq) (Equation 30)

Na₂CO₃(aq)+2HCl(aq)->2NaCl(aq)+CO₂(g)+H₂O(aq) (Equation 31)

The following reaction according to Equation 32 takes place in lime addition tank 468.

Na₂SO₄(aq)+Ca(OH)₂(aq)+H₂O(aq)->CaSO₄.2H₂O(s)+2NaOH(aq) (Equation 32)

Step 6. The mixture via stream 478 from lime addition tank 468 goes through the filtration process via a pump 480 having an output 482 to the filter unit 484. The liquid stream 486 from the filter unit 484 is recycled to the tank 404 through heat exchanger 488 to remove heat of reaction. Alternatively, the heat exchanger 488 may be integrated into the reaction tanks 468 and/or 446. Alternatively, the heat exchanger 488 may also be located between pump 480 and filtration process 484, or between pump 462 and filtration process 466, or between filtration process 466 and lime addition tank 468. The solids stream 490 containing calcium sulfate is taken out of the process.

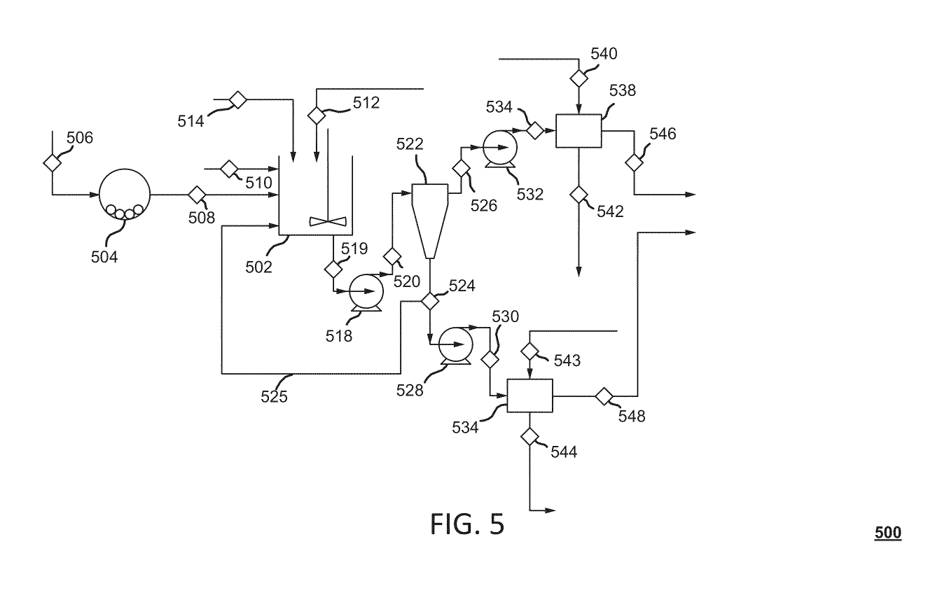

FIG. 5 illustrates an exemplary diagram of a process and system for separation of calcium carbonate and fly ash by-products according to another embodiment of the invention.

Referring to FIG. 5, the process is generally shown with reference to number 500. This process embodiment is described with regard to Steps 1-2, but the processing may be conducted in any order and the order of the steps is used for simplicity of description only and the process is not intended to be limited to this specific order.

This is an optional add-on process which, when coupled with the processes of FIGS. 1-4 described herein, results in the separation of calcium carbonate and fly ash in the solids by-product stream from tank 502. The resulting fly ash stream is substantially free of calcium. Both the fly ash stream and the calcium carbonate stream are potentially salable as by-products. The process includes the addition of a mill unit 504 to reduce the average particle size of the incoming fly ash to a size of about 20 μm or less, and the addition of a solids separation device such as a hydrocyclone and an additional filtration process to facilitate the separation of the fly ash/calcium carbonate solids mixture on the basis of particle size.

Step 1. Fly ash collected from the particulate removal device of the power plant having a sodium-based dry sorbent injection (DSI) system is fed first to a grinding mill 504 via stream 506 where the average particle size is reduced to about 20 μm or less. The fly ash contains sodium sulfate and residual sodium carbonate from the reaction of dry sorbent with the flue gas in the DSI process. The milled fly ash is then fed to the mixing tank 502 through stream 508. Water is added to the tank 502 via stream 510 if additional water other than the cake wash water 540 is needed for water balance. The residence time for the mixture in tank is in a range of about 30 to about 60 minutes or greater. Sodium carbonate dissolves into solution, while the sodium sulfate does not since at steady state sodium sulfate will reach saturation due to high concentrations in the recycle stream 512. Due to formation of NaOH in the mixing tank 502, the OH⁻ concentration increases to approximately 0.5-0.7 (pH˜13 or greater). The following reactions according to Equations 33 and 34 take place in the mixing tank 502, utilizing native CaO in the fly ash.

CaO(s)+H₂O(aq)->Ca(OH)₂(aq) (Equation 33)

Na₂CO₃(aq)+Ca(OH)₂(aq)->CaCO₃(s)+2NaOH(aq) (Equation 34)

Depending on the CaO concentration in the fly ash, external lime via stream 514 may be added as required to reach the target for conversion of Na₂CO₃ to CaCO₃ and NaOH.

Step 2. The slurry from the mixing tank 502 via stream 519 is pumped with a pump 518 via stream 520 to a separation device 522, e.g., a hydrocyclone. The separation device 522 is configured to allow larger calcium carbonate particles to exit in the bottom fraction of the hydrocyclone via stream 524, while the smaller fly ash (and Na₂SO₄) particles exit in the top stream 526 fraction of the hydrocyclone output. Optionally, a fraction of the bottom fraction stream 524 can be recycled back to the mixing tank 502 via stream 525 to increase the size of the calcium carbonate crystals and improve the solids separation in hydrocyclone 522.

The solid streams are sent to dedicated filtration processes. Calcium carbonate fraction solids via stream 524 are sent with a pump 528 via stream 530 to a filtration unit 534. Fly ash fraction solids via stream 526 are sent with a pump 532 via stream 536 to a filtration unit 538. Optionally, filtration unit 538 can include a cake wash 540 and filtration unit 534 can include a cake wash 543 to recover any soluble sodium from the cakes to maximize sodium bicarbonate yield later in the processes. The output stream 542 includes fly ash and Na₂SO₄ and output stream 544 includes CaCO₃. Liquid outputs 546 and 548 out of the filtration processes 538, 534, respectively are fed to the sparging tank via a heat exchanger to remove heat of reaction. Alternatively, the heat exchange may be integrated into the reaction tank 502. The concentrations of NaOH and Na₂SO₄ in the solution are in a range from about 0.5 to about 1.1 M and in a range from about 0.4 to about 1.1 M, respectively, as modeled by our laboratory tests. The concentration of Na₂CO₃ in the initial mixture in tank 502 as modeled by our laboratory tests is 0.5 M. In actuality, the initial Na₂CO₃ concentration will be dependent on the normalized stoichiometric ratio (NSR) of the DSI process. The concentration of Na₂CO₃ leaving tank 502 is dependent on the concentration of lime in the fly ash as well as the amount of additional lime (if any) added in stream 514. The remainder of the process is identical to that of the embodiments described above.

### EXAMPLES

Without intending to limit the scope of the invention, the following examples illustrate how various embodiments of the invention may be performed, made and/or used.

A normalized stoichiometric ratio (NSR, mole of Na₂ injected/mole of SO₂ in the gas inlet) for trona of 3.2 was assumed, which corresponds to about a 90 percent (%) removal of SO₂ in a power plant utilizing a baghouse for particulate matter control. This usage indicates that a large amount of the reactive portion of trona remains unused, and will be found in the fly ash as sodium carbonate due to calcination of the trona in the DSI process. The approximate composition of fly ash collected downstream of a DSI system operating at an NSR of 3.2 when low sulfur coal is burned were calculated by mass balance and are given below in Table 1. This estimated post-DSI fly ash composition was used as the basis for the Examples reported herein.

TABLE 1
Estimated Fly Ash Composition

| | Approximate |
|---|---|
| Component | weight % |
| Fly ash | 57 |
| Na₂CO₃ | 28 |
| Na₂SO₄ | 15 |

The fly ash used in Examples 1-5 and 15-16 was obtained from Powder River Basin (PRB) coal fired plants and includes silica, alumina, iron oxides, and calcium-bearing minerals. The trace elements included mercury, chromium, and titanium, among others in concentration range of about 0.1 percent (%) to about 2 percent (%). Sodium carbonate and sodium sulfate were added to the PRB fly ash as specified herein in Table 1 to simulate post-DSI fly ash.

### Examples 1-5

Examples 1-5 detailed herein serve as proof of concept experiments to demonstrate the reaction between sodium carbonate and lime found in post-DSI fly ash. It is expected that reaction yields will increase with additional process optimization as known in the art.

Step 1:

(Formation of sodium hydroxide) This Step involves the formation of sodium hydroxide from the reaction between Na₂CO₃ and Ca(OH)₂ according to Equation 1 herein.

In Examples 1 to 5, the setup included a stirred 4 liter beaker. Reactants shown in Table 2 were added to the beaker in the quantities specified in the Table 2. These were stirred at ambient temperature and pressure for an hour and then filtered through a vacuum filtration apparatus.

Next, the pH of the filtrate was measured and the hydroxide concentration was determined by titration. The solids included fly ash and CaCO₃, these solids precipitated from the reaction between Na₂CO₃ and Ca(OH)₂ according to Equation 1. The solids were then weighed and the compositions were determined by x-ray diffraction (XRD). The results are shown in Table 2.

In Examples 1-3 excess lime was added in addition to the native lime found in the fly ash to ensure complete reaction of sodium bicarbonate to form sodium hydroxide and precipitate calcite. Stoichiometrically, not enough lime is present in the fly ash alone to completely convert all of the Na₂CO₃ to NaOH (dependent on NSR). In Examples 4 and 5 no additional lime was added and only the native lime in fly ash reacted with the sodium carbonate to form sodium hydroxide and calcite. Subsequent laboratory tests have shown that it is not necessary to convert all of the Na₂CO₃ to NaOH before synthesis of NaHCO₃. Table 2 summarizes Examples 1 to 5.

TABLE 2
Illustrating Examples 1-5 of the reaction between CaO in fly ash and
Na₂CO₃ to form insoluble CaCO₃

| | | | Ex- | Ex- | Ex- |
|---|---|---|---|---|---|
| | Example 1 | Example 2 | ample 3 | ample 4 | ample 5 |
| Reactants | | | | | |
| Fly ash, g | 114.3 | 114.7 | 56.9 | 117.5 | 116.4 |
| Na₂CO₃, g | 55.9 | 56.1 | 28.0 | 50.3 | 56.2 |
| Na₂SO₄, g | 30.7 | 29.8 | 15.0 | 30.2 | 29.1 |
| CaO, g | 14.8 | 14.7 | 13 | 0 | 0 |
| Water, g | 950 | 1000 | 400 | 980 | 980 |
| Products | | | | | |
| Filtrate, g | 949.4 | 1072.3 | 983.5 | 939.3 | 966.8 |
| [OH⁻], mol/L | 0.71 | 0.66 | 0.79 | 0.56 | 0.56 |
| pH | 13.45 | 13.32 | 13.57 | 13.12 | 13.03 |
| Solids, g | 149 | 144.07 | 82.3 | 122.3 | 125.4 |
| XRD analysis | | | | | |
| silica, SiO₂ | 32.0% | 32.2% | 30.6% | 48.0% | 45.1% |
| calcite, CaCO₃ | 42.5% | 42.0% | 43.1% | 26.8% | 27.2% |
| lime, Ca(OH)₂ | 25.0% | 285.0% | 65.0% | 0.0% | 0.0% |
| mullite, Al₆,Si₂O₁₃ | 23.0% | 23.3% | 19.9% | 25.2% | 27.7% |

### Examples 6-10

Examples 6 to 10 detailed here served as characterization experiments for product yield and purity as a function of NaCl concentration.

Step 2:

(Synthesis of sodium bicarbonate) Step 2 involves the synthesis of sodium bicarbonate from CO₂ and the sodium hydroxide generated in Step 1 as well as the residual, un-reacted sodium carbonate from Step 1 as per Equations 2 and 3 herein. NaCl is added to the solution in order to promote the precipitation of NaHCO₃ but it is not consumed in the reaction.

The laboratory apparatus for Step 2 includes a flask with a fitted disk sitting on the bottom which is configured for CO₂(g) flow. The filtrate from Step 1 is placed in the flask and nominally about 15 percent (%) NaCl by weight is added. When the NaCl is dissolved, CO₂ (g) is bubbled through the solution at ambient temperature for a minimum of 40 minutes up to 1 hour. A white precipitate forms. The mixture is filtered through a vacuum filtration apparatus and the solid is dried overnight in a vacuum oven at 40° C. Tests have been conducted with varying amounts of NaCl from 5 percent (%)-25 percent (%).

Before it progresses to Step 3, the filtrate from the above reaction is analyzed for residual NaHCO₃ by titration. The pH is also obtained. The purity of the NaHCO₃ product is analyzed three ways: by titration for HCO₃⁻, by XRD for salt content, and by thermogravimetric analysis (TGA) for total purity. Table 3 summarizes the results of these examples that demonstrate Step 2 of the DSI recovery process, where yield is expressed with respect to the NaOH in the Step 1 filtrate.

TABLE 3
Illustrating Examples 6-10 of the synthesis of NaHCO₃ that demonstrate
Step 2 of the process

| | | Exam- | | | Exam- |
|---|---|---|---|---|---|
| | Example 6 | ple 7 | Example 8 | Example 9 | ple 10 |
| Reactants | | | | | |
| Filtrate from | 377.7 | 377.5 | 373.3 | 378.9 | 384.0 |
| Step 1, g | | | | | |
| [OH−], mol/L | 0.51 | 0.51 | 0.5 | 0.51 | 0.51 |
| NaCl, g | 94.5 | 75.5 | 56.3 | 37.8 | 19.2 |
| CO₂ flow rate | high | high | high | high | high |
| Products | | | | | |
| Filtrate, g | 431.5 | 425.6 | 388.1 | 391.1 | 375.4 |
| [HCO₃⁻], mol/L | 0.62 | 0.62 | 0.62 | 0.49 | — |
| pH | 8.94 | 8.77 | 7.67 | 7.83 | 7.31 |
| Solids, g | 17.9 | 18.6 | 15.1 | 13.8 | 0.0 |
| Purity by TGA | 81.1% | 84.8% | 88.3% | 94.4% | — |
| Yield of | 96.8% | 96.4% | 90.3% | 86.9% | — |
| NaHCO₃ | | | | | |

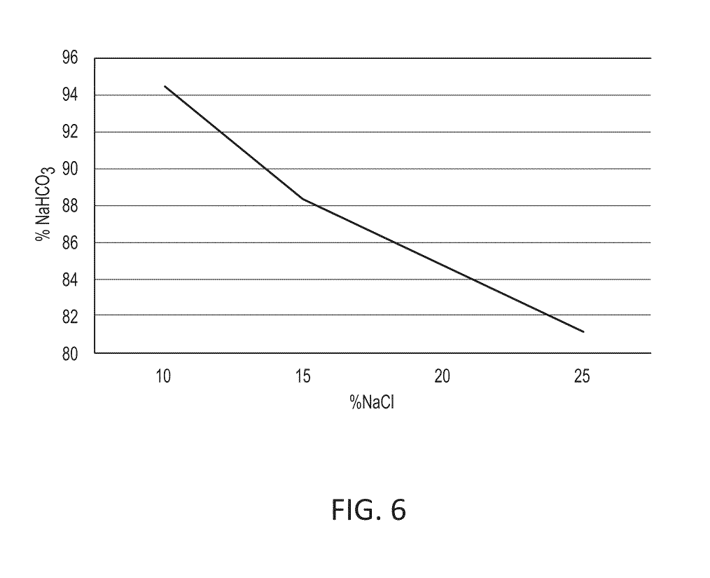

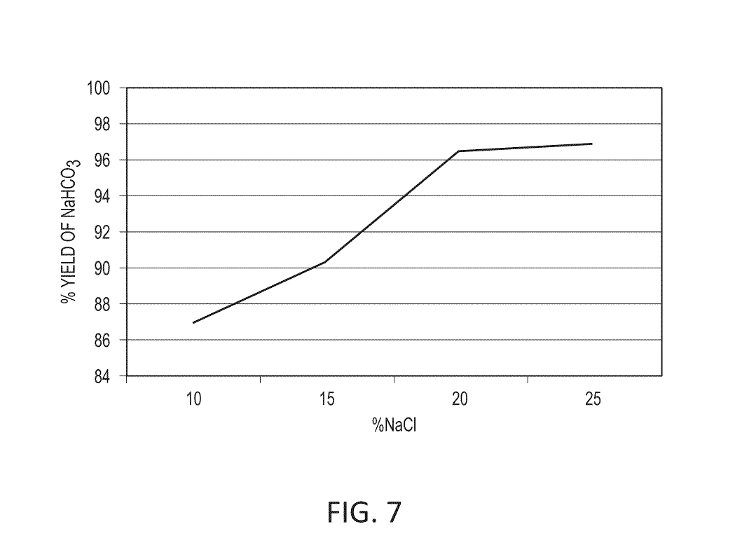

The above results not only illustrate the ability to precipitate NaHCO₃ in the absence of aqueous ammonia, they also illustrate the effect of varying salt concentrations on the purity of the product. In Example 6, 25 percent (%) NaCl by weight is added to the filtrate from Step 1. In Examples 7-10 the weight percent of NaCl drops by 5 percent (%) each time. Although the yield of NaHCO₃ increases when more salt is used, the purity of the product suffers. FIG. 6 illustrates this point by graphically illustrating NaHCO₃ when precipitated from solutions containing NaCl according to Examples 6-9. Example 10 indicates that when the salt content is 5 percent (%) or less, no NaHCO₃ precipitates out of the solution. Future experiments kept the concentration of NaCl at 10 percent (%). The percent recovery of NaHCO₃ with varying NaCl concentrations shows an obvious trend as does the purity levels of NaHCO₃. In this case the relationship is inverted with the lowest percent (%) recovery found at 5 percent (%) NaCl and the highest found at 25 percent (%) NaCl. The reason for this trend becomes obvious when considering the solubility equilibrium of NaHCO3. The higher the NaCl concentration, the less soluble the NaHCO₃. This trend is illustrated in FIG. 7 showing a percent recovery of NaHCO3 with increasing NaCl concentration.

### Examples 11-13

Examples 11-13 detailed herein serve as proof of concept experiments to demonstrate the reaction between the filtrate leaving Step 2 and an alkaline earth metal hydroxide. It is expected that reaction yields will increase with additional process optimization as known in the art.

Step 3:

(Precipitation of alkaline earth (AEM) carbonate and alkaline earth (AEM) sulfate) In this Step 3, two reactions are possible: i) the remaining soluble sodium bicarbonate from Step 2 is converted to sodium carbonate and/or sodium hydroxide, depending on AEM stoichiometry, and an alkaline earth carbonate (Equations 4 and 5), and ii) the sodium sulfate is precipitated as an alkaline earth sulfate (Equation 6). In general, the reactions are performed consecutively so that the carbonate and sulfate can be recovered separately.

In these examples the reactions take place in a stirred beaker at ambient temperature. After 1 hour the product is filtered using vacuum filtration and the solid is dried in a vacuum oven prior to being weighed. At several junctures some volume of the filtrate is removed for analysis. The pH of the filtrate is determined, and the filtrate is then analyzed for total hydroxide concentration, [OH⁻], and total carbonate concentration, [HCO₃—], by titration with HCl. The solid is analyzed by XRD.

The results are shown in Table 4, which also describes the conditions under which the reactions between sodium sulfate and an alkaline earth hydroxide were performed. When the alkaline earth is calcium, the reaction is limited by the hydroxide concentration at equilibrium, 0.15M. The reaction does not proceed once that concentration is reached. Therefore, in the first two examples the lime does not continue to react after the equilibrium concentration of 0.15M is reached. The reaction between barium hydroxide and sodium sulfate is not limited by the hydroxide concentration. In Example 13, Ba(OH)₂ is added to a 0.69M [OH—] solution. The reaction proceeds until the hydroxide concentration is 0.95M and BaSO₄ is precipitated.

TABLE 4
Illustrating Examples 11 to 13 of the reaction in Step 3

| | Example 11 | Example 12 | Example 13 |
|---|---|---|---|
| Reactants | | | |
| Water, g | 400 | 533.2 | 300 |
| Na₂SO₄, g | 29.6 | 25.1 | 10.6 |
| NaOH | — | — | 9.0 |
| CaO, g | 15.4 | 7.6 | — |
| Ba(OH)₂•8H₂O, g | — | — | 13.2 |
| Products | | | |
| Filtrate, g | 431.5 | 554.0 | 150.1 |
| [OH⁻], mol/L | 0.15 | 0.14 | 0.95 |
| pH | 13.11 | 13.08 | 13.81 |
| Solids, g | 23.7 | 10.9 | 9.0 |
| XRD analysis | | | |
| CaSO₄•2H₂O | 51.9% | 65.3% | — |
| CaO | 3.6% | 20.0% | — |
| Ca(OH)₂ | 44.5% | 14.8% | — |
| BaSO₄ | — | — | 100.0% |

### Example 14

Example 14 detailed herein serves as a proof of concept experiment to demonstrate the reaction between the filtrate leaving Step 2 and an alkaline earth metal hydroxide. It is expected that reaction yields will increase with additional process optimization as known in the art.

In this Example 14, a reaction was conducted identically as those in Examples 11 to 13. The solution was composed of 0.60M NaHCO₃ and 0.70M Na₂SO₄. First, Ba(OH)₂ was added to the mixture and a solution of 0.14M NaOH formed as a result of the precipitation of a mixture of BaSO₄ and BaCO₃. After filtration, Ca(OH)₂ was added and the reaction proceeded to produce CaCO₃ and NaOH, resulting in an increase of the hydroxide concentration to 0.68M. At several stages of this reaction samples of the filtrates were removed to obtain analyses. Table 5 shows the results of the reaction between Na₂SO₄ and an alkaline earth hydroxide.

TABLE 5
Illustrates Example 14 summarizing a two stage reaction with
alkaline earth hydroxides

| | Example 14 |
|---|---|
| Reactants | |
| Water, g | 500 |
| Na₂SO₄, g | 49.4 |
| NaHCO₃, g | 28.6 |
| NaCl, g | 59.7 |
| Ba(OH)₂•8H₂O, g | 88.1 |
| Ca(OH)₂, g | 5.4 |
| Products | |
| Filtrate from reaction with Ba(OH)₂, g | 425.2 |
| [OH⁻], mol/L | 0.14 |
| [HCO₃⁻], mol/L | 0.53 |
| pH | 13.15 |
| Filtrate from reaction with Ca(OH)₂, g | 243.9 |
| [OH⁻], mol/L | 0.68 |
| [HCO₃⁻], mol/L | 0.23 |
| pH | 13.74 |
| XRD analysis of solid from reaction with Ba(OH)₂ | |
| BaSO₄ | 72.1% |
| BaCO₃ | 27.9% |
| XRD analysis of solid from reaction with Ba(OH)₂ | |
| CaCO₃ | 100.0% |

### Examples 15-20

In Examples 15-20, a batch mode system for DSI recovery having a process flow similar to the one shown in FIG. 1 was constructed. The various components and inputs of the system were sized to produce 200 lb/day of sodium bicarbonate product. A first, second, and third tank were placed in series. The first and third mixing tanks included an agitated mixing tank having a 100 gal size. The second sparging tank, which was also an agitated mixing tank having a 100 gal size, was fitted with a sparging manifold and pure CO₂ was used as the CO₂ source. The filtration steps were performed using two filter presses, each with a capacity of 1 ft³. A single filter press was configured to remove solids from tank 1 and tank 3, similar to what's shown in FIG. 1 as block 111. The batches from tank 1 and tank 3 were run through the first press consecutively though rather than concurrently. The second filter press was dedicated to filtering the sodium bicarbonate product from Step 2, to eliminate the possibility of product purity degradation due to cross contamination with residual solids from Step 1 and/or Step 3. The filtrate from the Step 3 filtration process was recycled to Step 1.

The input to the system was Class C fly ash from a pulverized coal plant burning PRB coal. The fly ash was mixed with sodium carbonate and sodium sulfate in the amounts shown in Table 6 below in order to simulate post-DSI fly ash for a system running at an NSR of 3.2 (see also Table 1). The experimental results for two consecutive batches are shown below in Tables 7-9, with the examples defined as follows.

In Example 15 a first batch process was performed according to Equations in Step 1 as described in this Example section. In Example 16 a second batch process was performed according to Equations in Step 1 as described in this Example section. In Example 17 a first batch process was performed according to Equations in Step 2 as described in this Example section, utilizing the filtrate from Example 15. In Example 18 a second batch process was performed according to Equations in Step 2 as described in this Example section, utilizing the filtrate from Example 16. In Example 19 a first batch process was performed according to Equations in Step 3 as described in this Example section, utilizing the filtrate from Example 17. In Example 20 a second batch process was performed according to Equations in Step 3 as described in this Example section, utilizing the filtrate from Example 18.

In these Examples, NaCl concentration was kept constant at ˜10 percent (%) w/w through addition to the first mixing tank as reported in Table 6. Na₂CO₃ and NaHCO₃ concentrations in the various filtrates were determined by total inorganic carbon (TIC) analysis. NaOH concentrations were determined by a combination of total alkalinity titrations and TIC analysis.

Overall mass balance checks were performed for Examples 15 to 20. Mass balances were shown to close with a reasonable degree of accuracy, with absolute percent (%) error in the mass balances ranging from 0.5 percent (%) to 3.6 percent (%) as shown in Tables 6-8.

Sodium bicarbonate product purity was measured to be 80 percent (%) and 85 percent (%) for Examples 17 and 18 respectively as measured by thermogravimetric analysis (TGA). The main impurities in the product were determined to be NaCl (as determined by XRD) and aluminum hydroxide (as determined by SEM with EDX). Aluminum hydroxide enters the system with the fly ash as alumina, and is soluble in the high pH of step 1 but insoluble in the lower pH of step 2. It is expected that product purity will increase with additional process optimization as known in the art.

Yield as a percentage of sodium carbonate entering the system in Step 1 was determined to be 80 percent (%) and 73 percent (%) for Examples 17 and 18 respectively. Yields as high as 94 percent (%) were demonstrated at the lab scale where cake wash efficiency for the filter cake formed in Step 1 was higher. It is expected that a yield equivalent to that demonstrated at the lab scale will be achieved through optimization of the cake wash efficiency.

TABLE 6
Step 1 results of Examples 15 and 16

| | Example 15 | Example 16 |
|---|---|---|
| Reactants | | |
| Filtarte from Step 3, lbs | 635 | 650 |
| [OH⁻], mol/L | 0.42 | 0.48 |
| [CO₃²⁻], mol/L | 0.02 | 0.01 |
| Fly ash, lbs | 73 | 73 |
| Na₂CO₃, lbs | 37 | 37 |
| Na₂SO₄, lbs | 20 | 20 |
| NaCl make-up, lbs | 0 | 12 |
| H₂O, lbs | 113 | 101 |
| Products | | |
| Filtrate, lbs | 772 | 757 |
| [OH⁻], mol/L | 0.62 | 0.61 |
| [CO₃²⁻], mol/L | 0.30 | 0.31 |
| pH | 13.6 | 13.6 |
| Wet solids, lbs | 120 | 125 |
| Dry solids, lbs | 98 | 104 |
| Mass balance check | | |
| Mass in, lbs | 877 | 892 |
| Mass out, lbs | 892 | 882 |
| Difference in-out, lbs | −15 | 10 |
| % difference | −1.7% | 1.1% |

TABLE 7
Step 2 results Examples 17 and 18

| | Example 17 | Example 18 |
|---|---|---|
| Reactants | | |
| Filtarte from Step 1, lbs | 771 | 756 |
| [OH⁻], mol/L | 0.62 | 0.61 |
| [CO3²⁻], mol/L | 0.30 | 0.31 |
| CO₂ lbs | 40 | 39 |
| Products | | |
| Filtrate, lbs | 724 | 702 |
| [HCO₃⁻], mol/L | 0.40 | 0.39 |
| pH | 7.5 | 7.8 |
| Wet solids, lbs | 77 | 64 |
| Dry solids, lbs | 58 | 50 |
| Purity by TGA | 80% | 85% |
| Yield of NaHCO₃ | 80% | 73% |
| Mass balance check | | |
| Mass in, lbs | 811 | 795 |
| Mass out, lbs | 801 | 766 |
| Difference in-out, lbs | 10 | 28 |
| % difference | 1.2% | 3.6% |

TABLE 8
Step 3 results Examples 19 and 20

| | Example 19 | Example 20 |
|---|---|---|
| Reactants | | |
| Filtrate from Step 2, lbs | 722 | 701 |
| [HCO₃⁻], mol/L | 0.40 | 0.39 |
| CaO, lbs | 24 | 25 |
| Products | | |
| Filtrate, lbs | 685 | 652 |
| [OH⁻], mol/L | 0.48 | 0.48 |
| [CO₃²⁻], mol/L | 0.01 | 0.02 |
| pH | 13.6 | 13.6 |
| Wet solids, lbs | 69 | 70 |
| Dry solids, lbs | 50 | 48 |
| Mass balance check | | |
| Mass in, lbs | 746 | 725 |
| Mass out, lbs | 754 | 721 |
| Difference in-out, lbs | −8 | 4 |
| % difference | −1.0% | 0.5% |

As seen in Table 8, in Examples 19 and 20 the filtrate from Step 2 entering Step 3 contains some dissolved NaHCO₃ which is the first component of the stream to react with Ca(OH)₂ according to Equation 14. The reaction between Na₂SO₄ and Ca(OH)₂ shown in Equation 16 is limited by a maximum equilibrium value of 0.15M NaOH. Therefore, if the concentration of NaHCO₃ in the stream is greater than 0.15M the resulting hydroxide concentration prevents the reaction from occurring. In this case Na₂SO₄ accumulates in the recycle stream and eventually precipitates with the fly ash in Step 1 where the solubility of sodium sulfate is lowest. However, some sodium value can be recovered in Step 3 as described above in Equation 8.

### Example 21

In this Example 21, Toxicity Characteristic Leaching Procedure (TCLP) tests configured to determine the mobility of both organic and inorganic analytes present in the fly ash were conducted on three samples. Raw PRB fly ash is as collected from the particulate control device at a plant not running a DSI process. DSI fly ash is Raw PRB fly ash mixed with sodium carbonate and sodium sulfate to simulate post DSI fly ash as described in Table 1. Post process fly ash is Step 1 filter cake from the batch pilot system described in Examples 15-20. The samples were collected and subjected to a TCLP test conducted by an outside certified laboratory. The results are presented in Table 9 shown below.

In addition, the pH and sodium concentration of similar representative fly ash samples were measured in the lab and/or calculated by mass balance as shown in Table 10. In the lab, 10 percent (%) w/w solutions were prepared and mixed for 15 min. The solutions were then analyzed for pH and sodium concentration. Sodium concentration of the raw and post-process fly ash solutions were measured by ion chromatograph (IC) while the sodium concentration of the synthetic DSI fly ash was calculated by mass balance.

TABLE 9
Results from a TCLP leachability test for raw fly ash,
simulated DSI fly ash, and post process fly ash

| | | | Post Process Fly Ash, | |
|---|---|---|---|---|
| | Raw PRB Fly | | ppm | |
| | Ash, ppm | DSI Fly Ash, ppm | Sample #1 | Sample #2 |
| barium | 10.4 | ND | ND | ND |
| chromium | 0.066 | 0.18 | 0.25 | .037 |
| selenium | 0.084 | 0.48 | 0.071 | ND |
| arsenic | ND | 0.21 | 0.033 | ND |

Table 10 illustrates pH and sodium concentrations for raw fly ash, simulated DSI fly ash, and post process fly ash as determined in the lab.

TABLE 10

| | Raw PRB Fly Ash | DSI Fly Ash | Post Process Fly Ash |
|---|---|---|---|
| pH | 12.49 | 13.07 | 12.26 |
| [Na⁺], g/kg | ND | 86.3 | 31.1 |

The results show that as compared to untreated or processed PRB fly ash, that post DSI process fly ash obtained from Powder River Basin (PRB) coal fired plants that includes sodium salts shows higher concentrations of leachable arsenic and selenium. Also, the fly ash recovered after the trona recovery process similar to the processes of Examples 15 and 16 includes a much lower leachability of these elements, thereby confirming results of previous Examples. Moreover, the concentrations of arsenic and selenium in the post process fly ash fall far below the legislated limits of 5.0 ppm and 1.0 ppm, respectively.

Accordingly, the trona recycling process mitigates the effect of high sodium content on the increased leachability of toxic elements in two ways. The high pH that is the result of the initial reaction between lime and the sodium carbonate in the fly ash decreases the mobility of many toxic elements. More importantly, the process itself recovers a significant amount of the sodium content from the DSI fly ash thus removing the main cause of increased mobility of heavy elements. Moreover, due to the removal of sodium carbonate from the DSI fly ash during processing, the pH of post process fly ash is also decreased significantly.

### Example 22

In this Example, raw fly ash was milled to include a majority of the particle sizes being less than about 10 microns prior to being subjected to the DSI recycling process.

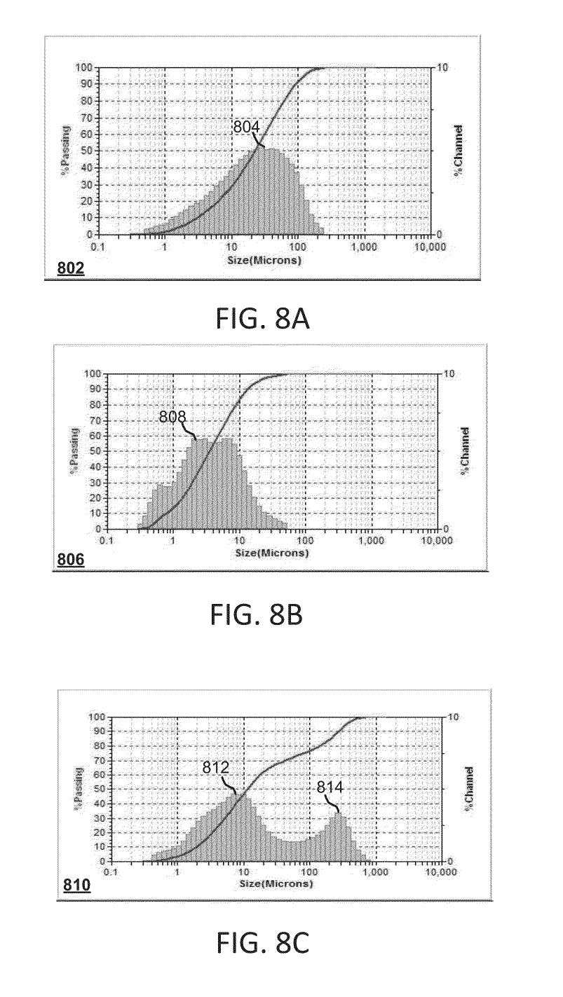

Step 1 was conducted using raw fly ash that was milled from a size from about 33.1 μm down to 4.5 μm as shown in FIGS. 8A and 8B. The initial size distribution 804 of raw fly ash used in this example is shown in FIG. 8A and generally depicted with reference to graph 802. FIG. 8B illustrates an exemplary graph 806 showing a particle size distribution 808 after milling the raw fly ash. Next, 117.5 g of milled fly ash, 50.3 g Na₂CO₃, and 30.2 g Na₂SO₄ were added to a 3 L beaker containing 980 mL of deionized water and stirred at ambient temperature and pressure for 1 hour. The solution was filtered by vacuum filtration to yield 880 mL of filtrate and 122.3 g of precipitate. The hydroxide concentration was determined by titration with HCl. The solid was analyzed by XRD for mineral composition and by Particle Size Analysis shown in FIG. 8C. Operating conditions and results are shown in Table 11.

FIG. 8C illustrates an exemplary graph 810 illustrating a particle size distribution of fly ash in an embodiment of the invention. Referring to FIG. 8C, the x-axis represents particle size in microns and the y-axis represents percent (%) of particles with the corresponding particle size. The particle size analysis of FIG. 8C is thought to be representative of solids generated from Step 1 of the continuous recovery process described with reference to FIG. 5 (pre-milling or sizing of fly ash) when the fly ash is milled to a size below 10 microns. The effect of this Step 1 is seen in the first step of the recovery process in which calcium carbonate is a byproduct. It is thought that as calcium carbonate forms, the crystals nucleate to form particle sizes mostly in a range of about 150 microns to about 250 microns.

The difference in size between the calcium carbonate particles and the residual fly ash suggests that they can be separated by density, preferably by hydrocyclone. The result would be a calcium-free fly ash product that possesses pozzolanic properties and is commonly used in virtually any concrete application including embankments, as road base, and in geopolymers.

Referring to FIG. 8C, there are clearly 2 peaks in the particle size analysis after Step 1 is conducted. A first peak 812 at 5-10 microns that corresponds to the milled fly ash and a second peak 814 that spans 150-250 microns that is thought to correspond to calcium carbonate. Therefore, as shown in FIG. 5 a hydrocyclone 522 or other suitable separating equipment may be used to separate the fly ash from calcium carbonate due to the size distribution shown in FIG. 8C.

TABLE 11

| | Example 21 |
|---|---|
| Reactants | |
| Water, g | 980 |
| milled fly ash, g | 117.5 |
| Na₂CO₃, g | 50.3 |
| Na₂SO₄, g | 30.2 |
| Products | |
| Filtrate, g | 939.3 |
| [OH⁻], mol/L | 0.48 |
| pH | 13.11 |
| Solids, g | 122.3 |
| XRD analysis | |
| SiO₂ | 48.0% |
| CaCO₃ | 26.8% |
| Al₆Si₂O₁₃ | 25.2% |
| PSA | |
| fly ash, μm | 6.1 |
| CaCO₃, μm | 186 |

The inventions and methods described herein can be viewed as a whole, or as a number of separate inventions, that can be used independently or mixed and matched as desired. All inventions, steps, processes, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for recovering at least a portion of dry sorbent from a solid waste of an industrial process utilizing a dry sorbent injection process for pollution reduction, comprising the steps of:
reacting the solid waste in at least one aqueous reaction to produce a reacted product; and
reacting the reacted product with carbon dioxide to recover the portion of the dry sorbent.

2. The method of claim 1, wherein the reacted product comprises at least one of sodium hydroxide and sodium carbonate.

3. The method of claim 1, wherein the solid waste comprises at least one of sodium sulfate and sodium carbonate.

4. The method of claim 3, wherein the step of reacting the solid waste further comprises the step of adding an alkaline earth metal hydroxide to the reacting step.

5. The method of claim 1, wherein the solid waste comprises post DSI fly ash.

6. The method of claim 1, wherein the dry sorbent comprises a material selected from the group consisting of trona, sodium bicarbonate, sodium carbonate, sodium sequicarbonate and combinations of the same.

7. The method of claim 1, wherein the reacting the solid waste step does not include a reaction with ammonia.

8. The method of claim 1, wherein the reacting the reacted product with carbon dioxide step does not include a reaction with ammonia.

9. The method of claim 1, further comprising the step of:
separating solids from the liquids in the reacted product to produce a recycled fly ash.

10. The method of claim 9, wherein the recycled fly ash comprises a sodium concentration less than a sodium concentration of the solid waste.

11. The method of claim 9, wherein the recycled fly ash comprises a sodium concentration of about 25 percent less than a sodium concentration of the solid waste.

12. The method of claim 9, wherein the recycled fly ash comprises a sodium concentration of about 50 percent less than a sodium concentration of the solid waste.

13. The method of claim 9, wherein the recycled fly ash comprises a leachability value of at least one or more of barium, chromium, selenium, and arsenic less than the leachability value of at least one or more of barium, chromium, selenium, and arsenic in the solid waste.

14. The method of claim 9, wherein the recycled fly ash comprises a leachability value of at least one or more of barium, chromium, selenium, and arsenic of about 25 percent less than the leachability value of at least one or more of barium, chromium, selenium, and arsenic in the solid waste.

15. The method of claim 9, wherein the recycled fly ash comprises a leachability value of at least one or more of barium, chromium, selenium, and arsenic of about 50 percent less than the leachability value of at least one or more of barium, chromium, selenium, and arsenic in the solid waste.

16. The method of claim 1, further comprising the steps of:
performing a dry sorbent injection process for pollution control with a dry sorbent comprising the recovered dry sorbent.

17. The method of claim 1, wherein the solid waste comprises post DSI fly ash from a coal fired plant that utilized a dry sorbent injection process and an activated carbon injection process for pollution reduction.

18. The method of claim 17, wherein the pollution control comprises removal of acid gases from a flue gas of a coal fired power plant.

19. A process for recovering product from a solid waste of a coal fired power plant combustion process utilizing a dry sorbent injection process, comprising:
mixing the solid waste and water to produce a mixture comprising at least one of calcium carbonate, sodium hydroxide, sodium carbonate and sodium sulfate;
subjecting the mixture to carbon dioxide to produce a product comprising a slurry mixture comprising one or more of sodium bicarbonate, trona, sodium sesquicarbonate and sodium carbonate;
separating solids and liquids from the product to produce liquid product and a solid product; and
subjecting the liquid product to an alkaline earth metal hydroxide to produce a mixture comprising one or more of an alkaline earth metal carbonate, sodium carbonate, and sodium hydroxide.

20. The process of claim 19, wherein the solid waste comprises trona.

21. The process of claim 19, wherein the solid waste comprises post DSI fly ash comprising at least one of sodium sulfate and sodium carbonate.

22. The method of claim 19, wherein the dry sorbent comprises a material selected from the group consisting of trona, sodium bicarbonate, sodium carbonate, sodium sequicarbonate and combinations of the same.

23. The method of claim 19, further comprising the steps of:
performing a dry sorbent injection process for pollution control with a dry sorbent comprising the recovered one or more of sodium bicarbonate, trona, sodium sesquicarbonate and sodium carbonate.

24. The method of claim 23, wherein the pollution control comprises removal of acid gases from the flue gas from the coal fired power plant.

25. A system for recovering sodium bicarbonate from a solid waste of an industrial process, comprising:
a first reactor unit operable to react an aqueous mixture of solid waste comprising sodium carbonate and calcium hydroxide to produce calcium carbonate and sodium hydroxide;
a second reactor unit in communication with the first reactor unit operable to react the sodium carbonate, sodium hydroxide and carbon dioxide to produce a second mixture comprising one or more of sodium bicarbonate, trona, sodium sesquicarbonate and sodium carbonate; and
a third reactor unit in communication with the second reactor unit operable to react the second mixture with an alkaline earth metal hydroxide to produce a third mixture comprising one or more of an alkaline earth metal carbonate, alkaline earth metal sulfate, sodium carbonate, and sodium hydroxide.

26. The system of claim 25, wherein the first reactor unit and third reactor unit comprises a stirred tank reactor.

27. The system of claim 25, wherein the second reactor unit comprises a gas liquid contactor.

28. The system of claim 25, further comprising a recycle stream from the third reactor unit to the first reactor unit, wherein the recycle stream is operable to transport one or more of an alkaline earth metal carbonate, sodium carbonate, and sodium hydroxide to the first reactor unit.

29. The system of claim 25, wherein the solid waste comprises post DSI fly ash from a coal fired plant that utilized a dry sorbent injection process for pollution reduction.

30. The system of claim 25, wherein the solid waste comprises post DSI fly ash from a coal fired plant that utilized a dry sorbent injection process and an activated carbon injection process for pollution reduction.

31. The system of claim 25, further comprising a solid liquid separator in communication with the first reactor unit operable to separate a recycled fly ash from the first reactor unit.

32. The system of claim 31, wherein the recycled fly ash comprises a sodium concentration of about 25 percent less than a sodium concentration of the solid waste.

33. The system of claim 31, wherein the recycled fly ash comprises a sodium concentration of about 50 percent less than a sodium concentration of the solid waste.

34. The system of claim 31, wherein the recycled fly ash comprises a leachability value of at least one or more of barium, chromium, selenium, and arsenic less than the leachability value of at least one or more of barium, chromium, selenium, and arsenic in the solid waste.

35. The system of claim 31, wherein the recycled fly ash comprises a leachability value of at least one or more of barium, chromium, selenium, and arsenic of about 25 percent less than the leachability value of at least one or more of barium, chromium, selenium, and arsenic in the solid waste.

36. The system of claim 25, further comprising a sizing unit in communication with the first reactor unit to reduce a particle size of the solid waste.

37. The system of claim 36, wherein the reduced particle size is in a range of about 25 microns or less.

38. The system of claim 25, wherein the alkaline earth metal comprises calcium.

39. The system of claim 25, wherein the alkaline earth metal comprises barium.

40. The system of claim 25, wherein the alkaline earth metal comprises strontium.

41. The system of claim 25, further comprising:
a dry sorbent injection unit for pollution reduction; and
a recycle stream from the system to the dry sorbent injection unit, wherein the recycle stream is configured to transport the recovered sodium bicarbonate.

42. The system of claim 25, further comprising:
a fourth reactor unit in communication with the third reactor unit operable to react the third mixture with a second alkaline earth metal hydroxide to produce a fourth mixture comprising a by-product.
